(19) United States
(12) Patent Application Publication
(10) Pub. No.: US 2025/0068250 A1
(43) Pub. Date: Feb. 27, 2025

(54) SCALABLE HANDWRITING, AND SYSTEMS AND METHODS OF USE THEREOF

(71) Applicant: Meta Platforms Technologies, LLC, Menlo Park, CA (US)

(72) Inventors: Swati Goel, Seattle, WA (US); Stephen McAnearney, Darien, CT (US)

(21) Appl. No.: 18/627,344

(22) Filed: Apr. 4, 2024

Related U.S. Application Data
(60) Provisional application No. 63/494,214, filed on Apr. 4, 2023.

(51) Int. Cl. G06F 3/01; G06F 1/16

(52) U.S. Cl. CPC G06F 3/017; G06F 1/163

(57) ABSTRACT

A method includes detecting, by a wearable device worn by a user, a text-symbolic hand gesture performed by the user. The method includes, in response to detecting the text-symbolic hand gesture, causing a display to present (i) a representation of an application-specific action associated with a character identified from the text-symbolic hand gesture and (ii) a predicted user input based on the character. The method includes detecting, by the wearable device, a subsequent input performed by the user. The method includes, in response to a determination that the subsequent input selects the predicted user input, providing instructions that cause the wearable device to initiate sending of the predicted user input to another electronic device; and, in response to a determination that the subsequent input selects the representation of the application-specific action associated with the character, providing instructions that cause the wearable device to initiate performance of the application-specific action.

### CROSS-REFERENCE TO RELATED APPLICATIONS

This application claims priority to U.S. Prov. App. No. 63/494,214, filed on Apr. 4, 2023, and entitled “Scalable Handwriting, and Systems and Methods of Use Thereof,” which is hereby incorporated by reference in its entirety.

### TECHNICAL FIELD

This relates generally to handwritten inputs including, but not limited to, techniques for detecting and determining characters performed by a user's handwriting.

### BACKGROUND

Handwriting is a natural method for communicating and interacting with others. In particular, each person has their owned personalized handwriting with which they express characters, digits, or symbols. Each person's handwriting is unique can carry a sense of familiarity, comfort, and privacy. Existing solutions attempt to utilize handwriting as an input method through the use of handheld devices, such a stylus. However, stylus are not always available and may not be acceptable or appropriate for simple text inputs. Similarly, other textual inputs, such as voice dictation, are not ideal for all contexts, can feel awkward to users, and are highly prone to errors. Further, D-pad text-based inputs can be slow and cumbersome for users.

As such, there is a need to address one or more of the above-identified challenges. A brief summary of solutions to the issues noted above are described below.

### SUMMARY

The systems and methods disclosed herein allow a user to provide handwritten inputs in an easy to use, frictionless, and socially accepted manner. Further, the systems and methods disclosed herein provide a number of scalable solutions that allow a user to increase the overall rate at which they provide textual inputs (e.g., increase the number of words per minute typed). Through use of the systems and methods disclosed herein, the user can use handwriting to improve the availability of devise for providing textual inputs. More specifically, the systems and methods disclosed herein allow a user to use a worn wearable device to provide handwriting as a textual input in a discrete, private, and socially acceptable manner.

One example of a method of determining textual inputs based on handwriting is disclosed. The method includes detecting, by a wearable device worn by a user, a text-symbolic hand gesture performed by the user. The method includes, in response to a determination that the text-symbolic hand gesture is associated with a character, determining a predicted user input based on the character and causing a display communicative coupled with the wearable device to present (i) the character and (ii) the predicted user input. The method further includes detecting, by the wearable device worn by the user, a subsequent hand gesture performed by the user. In response to a determination that the subsequent hand gesture selects the predicted user input, the method includes providing instructions that cause the wearable device to perform an operation associated with the predicted user input and, in response to a determination that the subsequent hand gesture selects the character, the method includes providing instructions that cause the wearable device to perform an operation associated with the character.

In some embodiments, the method is performed at a wrist-wearable device. In some embodiments, the method is performed at a head-wearable device. In some embodiments, the method is performed by a system including the head-wearable device and the wrist-wearable device. In some embodiments, a non-transitory, computer-readable storage medium includes instructions that, when executed by a wrist-wearable device, cause the wrist-wearable device to perform or cause performance of the method. In some embodiments, a non-transitory, computer-readable storage medium includes instructions that, when executed by a head-wearable device, cause the wrist-wearable device to perform or cause performance of the method.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below in conjunction with the following drawings in which like reference numerals refer to corresponding parts throughout the figures.

FIGS. 1A-1L illustrate example textual inputs provide by a user via a hand gesture detected by a worn wearable device, in accordance with some embodiments.

FIGS. 2A-2D illustrate an example of providing a text-symbolic hand gesture, in accordance with some embodiments.

FIGS. 3A-3F illustrate different examples of providing text-symbolic hand gestures, in accordance with some embodiments.

FIG. 4 illustrates electronic device availability through a user's day.

FIG. 5 illustrates a flow diagram of a method of detecting and determining one or more characters associated with a text-symbolic hand gesture performed by the user, in accordance with some embodiments.

FIGS. 6A-6B illustrate example artificial-reality systems, in accordance with some embodiments.

FIGS. 7A and 7B illustrate an example wrist-wearable device, in accordance with some embodiments.

FIGS. 8A-8C illustrate example head-wearable devices, in accordance with some embodiments.

FIGS. 9A and 9B illustrate an example handheld intermediary processing device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality, as described herein, is any superimposed functionality and/or sensory-detectable presentation provided by an artificial-reality system within a user's physical surroundings. Such artificial-realities (AR) can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. In some embodiments of an AR system, ambient light (e.g., a live feed of the surrounding environment that a user would normally see) can be passed through a display element of a respective head-wearable device presenting aspects of the AR system. In some embodiments, ambient light can be passed through respective aspect of the AR system. For example, a visual user interface element (e.g., a notification user interface element) can be presented at the head-wearable device, and an amount of ambient light (e.g., 15-50% of the ambient light) can be passed through the user interface element, such that the user can distinguish at least a portion of the physical environment over which the user interface element is being displayed.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

Hand gestures, as described herein, can include an in-air gesture, a surface-contact gesture, and or other gestures that can be detected and determined based on movements of a single hand or a combination of the user's hands. In-air means, in some embodiments, that the user's hand does not contact a surface, an object, or a portion of an electronic device (e.g., the head-wearable device 110 or other communicatively coupled device, such as the wrist-wearable device 120). In other words, the gesture is performed in open air, in 3D space, and without contacting a surface, an object, or an electronic device. Surface-contact gestures (contacts at a surface, object, body part of the user, or electronic device) are also more generally contemplated in which a contact (or an intention to contact) is detected at a surface (e.g., a single or double finger tap on a table, on a user's leg, a couch, etc.). The different hand gestures disclosed herein can be detected using image data and/or sensor data (e.g., neuromuscular signals sensed by one or more EMG sensors or other types of data from other sensors, such as proximity sensors, time-of-flight sensors, sensors of an inertial measurement unit, etc.) detected by a wearable device worn by the user and/or other electronic devices in the user's possession (e.g., smartphones, laptops, imaging devices, intermediary devices, and/or other devices described herein).

As described herein, one or more wearable devices worn by the user can be used to improve their overall efficiency and ease of providing textual inputs. The methods and devices described herein include methods and systems for detecting hand gestures performed by the user wearing a wearable device, such as a head-wearable device and/or wrist-wearable device, and determining one or more textual inputs (e.g., characters, words, symbols, phrase, acronyms, abbreviations, etc.) based on the performed hand gestures. As described herein, the hand gestures can be specific to a user to allow the user to incorporate their own shorthand and style of providing textual inputs over time. The systems and methods described herein allow a user to improve the rate at which they provide textual inputs by generating a shorthand based on the user's historical data. Further, the systems and methods described herein can detect a text-symbolic hand gesture based on visually imperceptible hand gestures, which improve the availability of the user's wearable devices by allowing them to provide inputs subtly, privately, and comfortably.

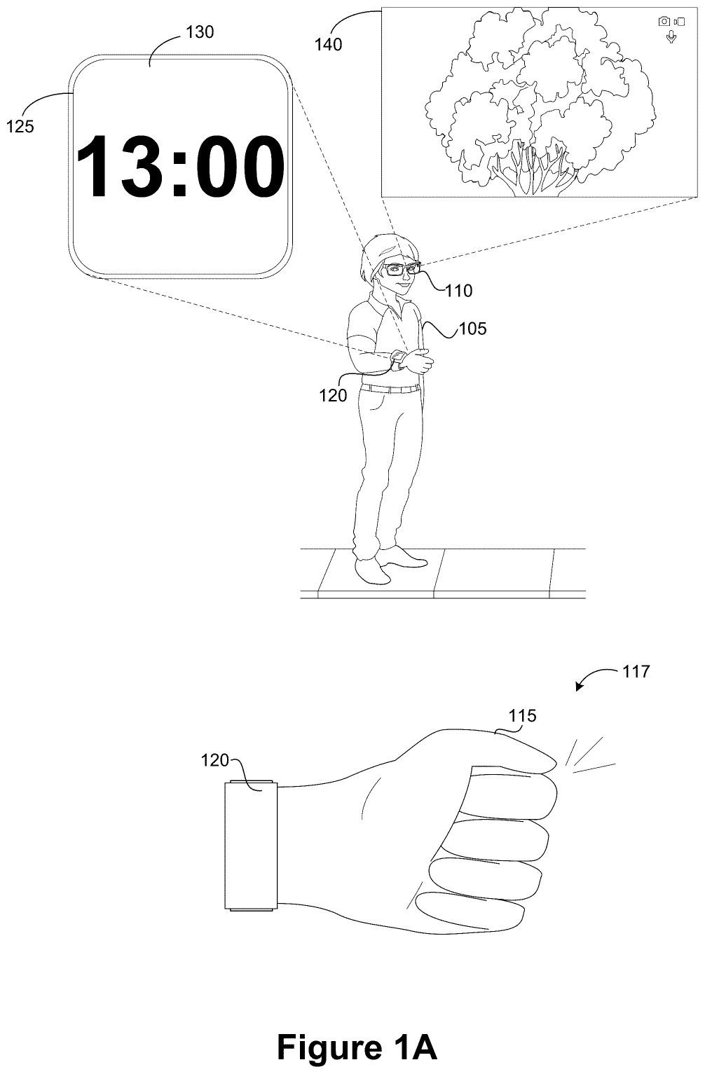

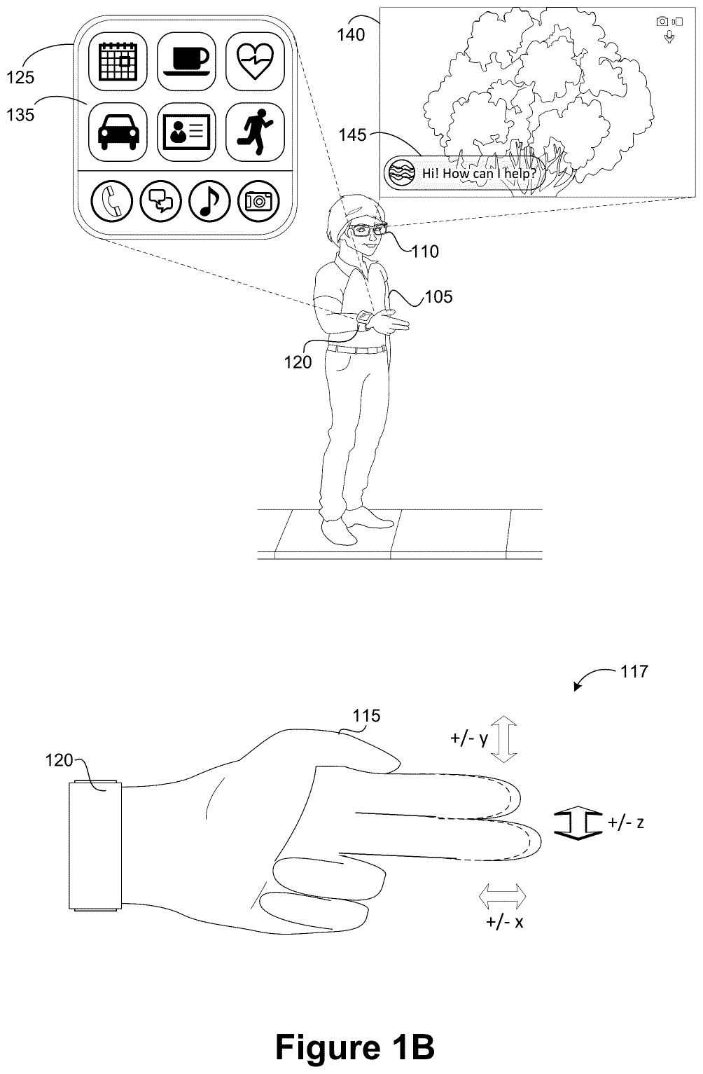

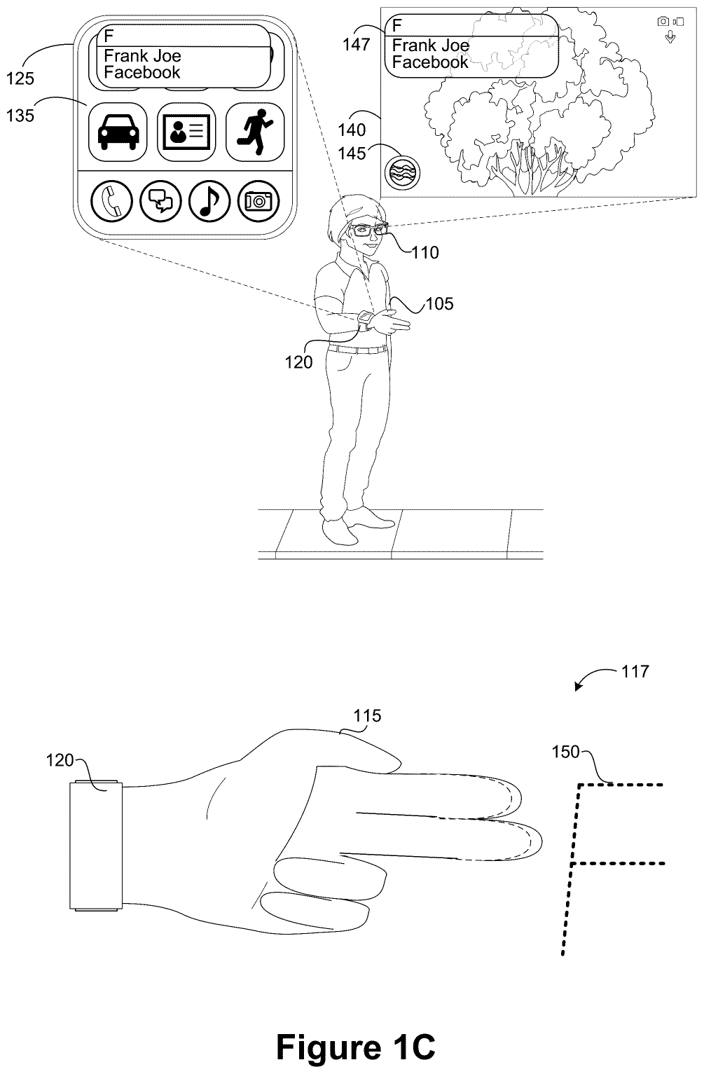

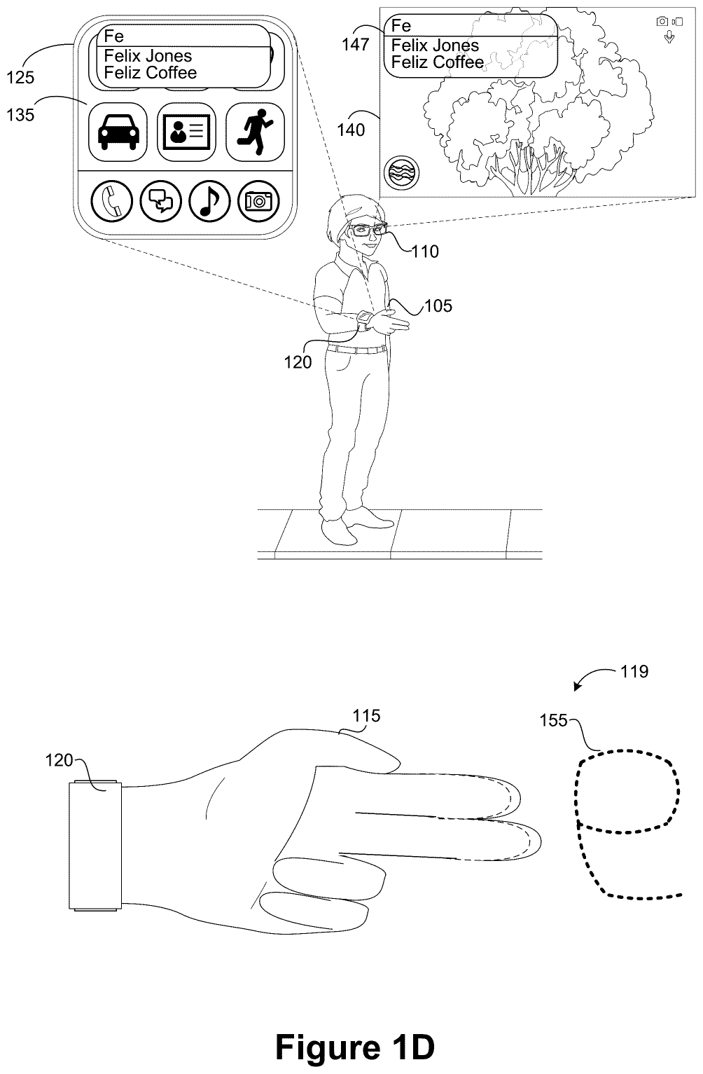

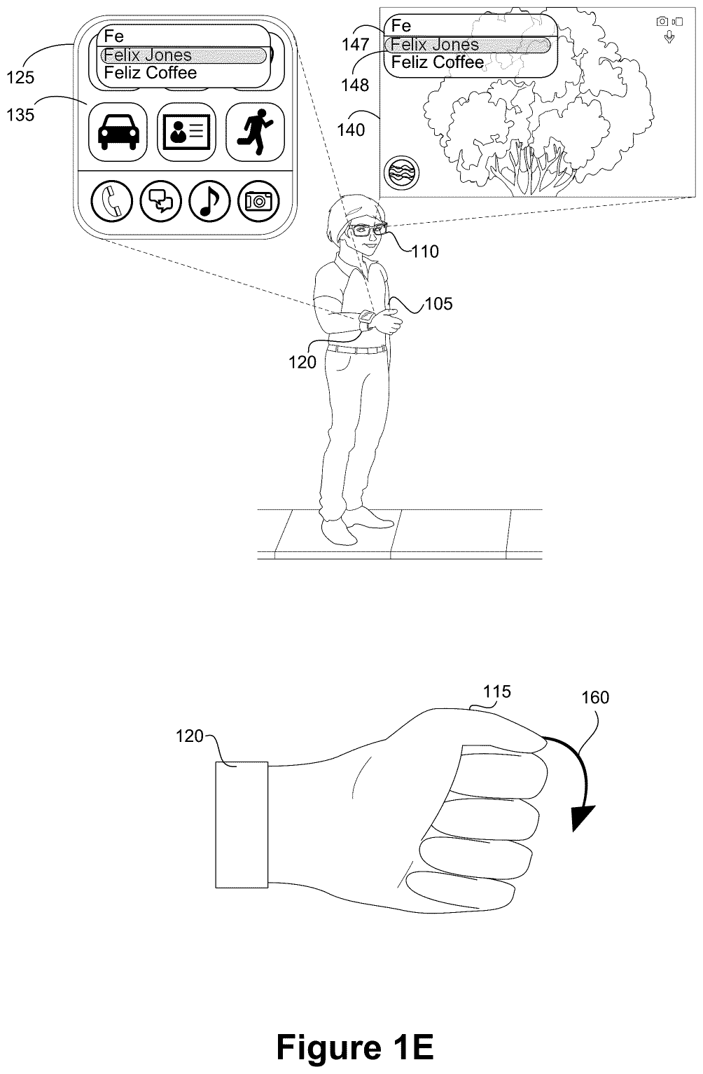

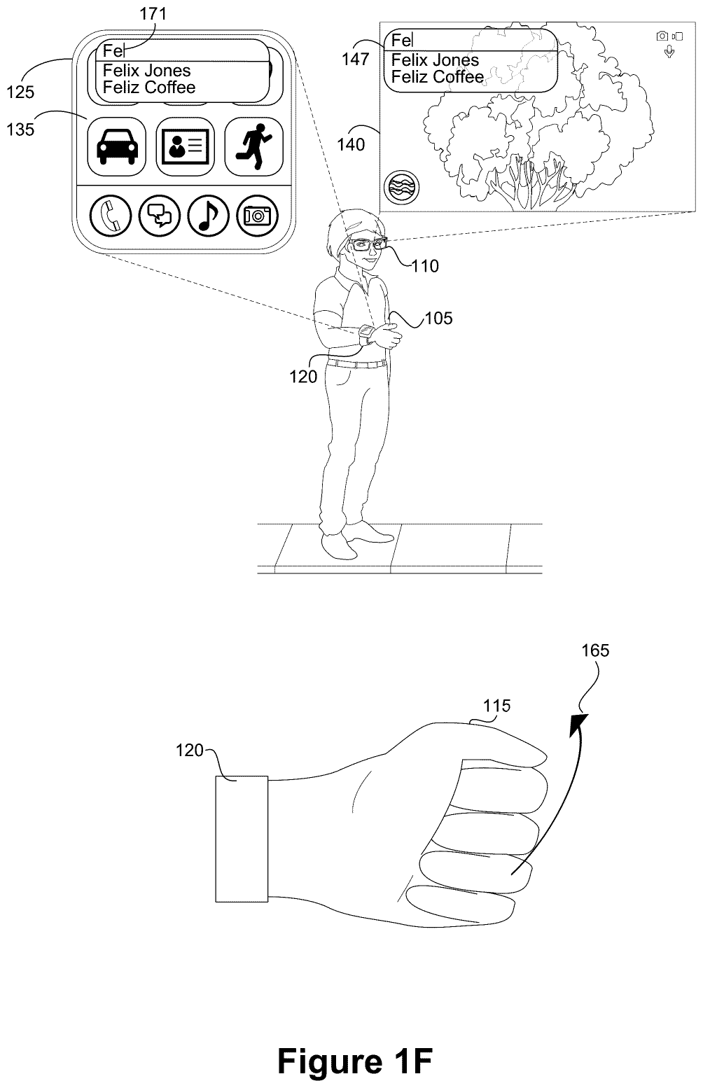

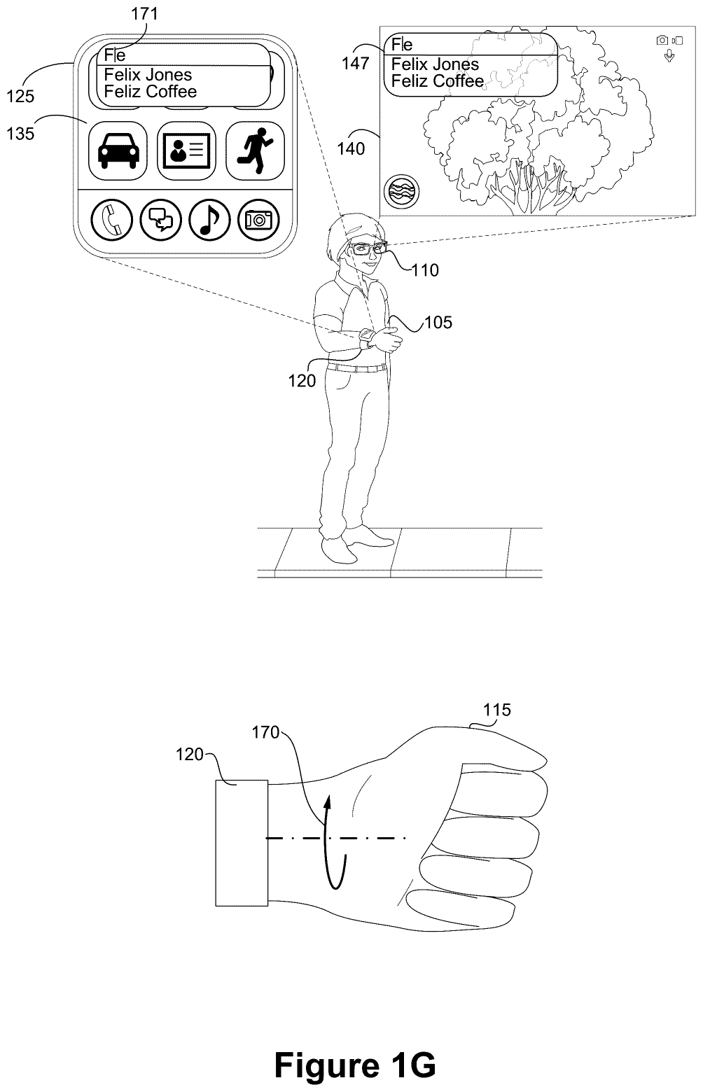

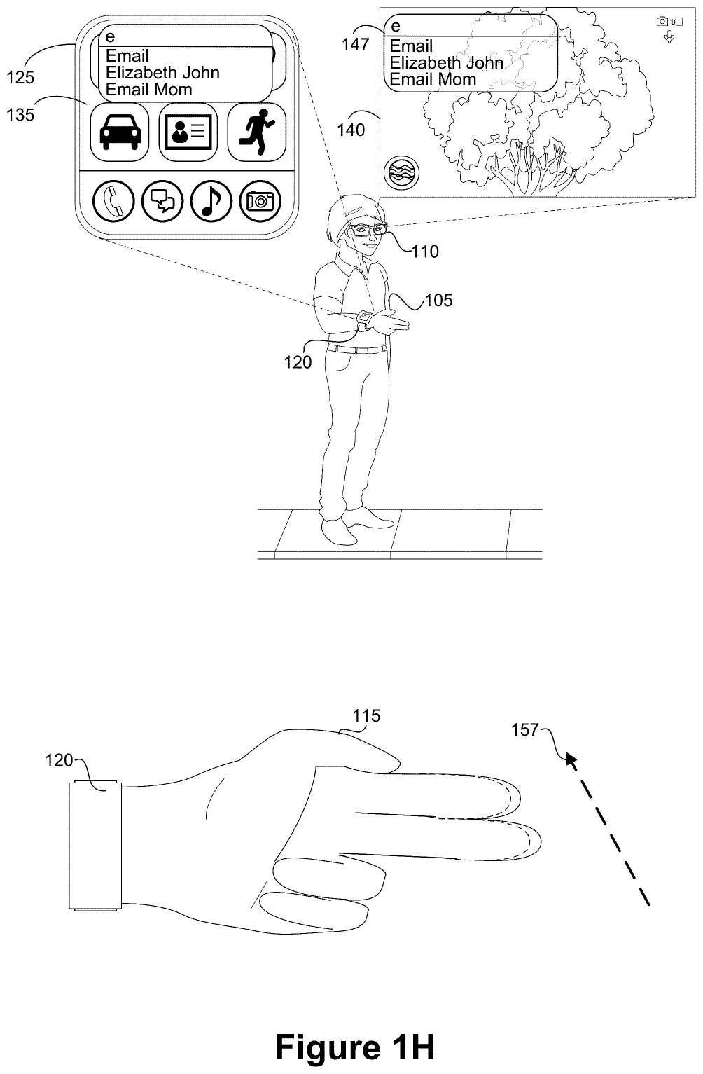

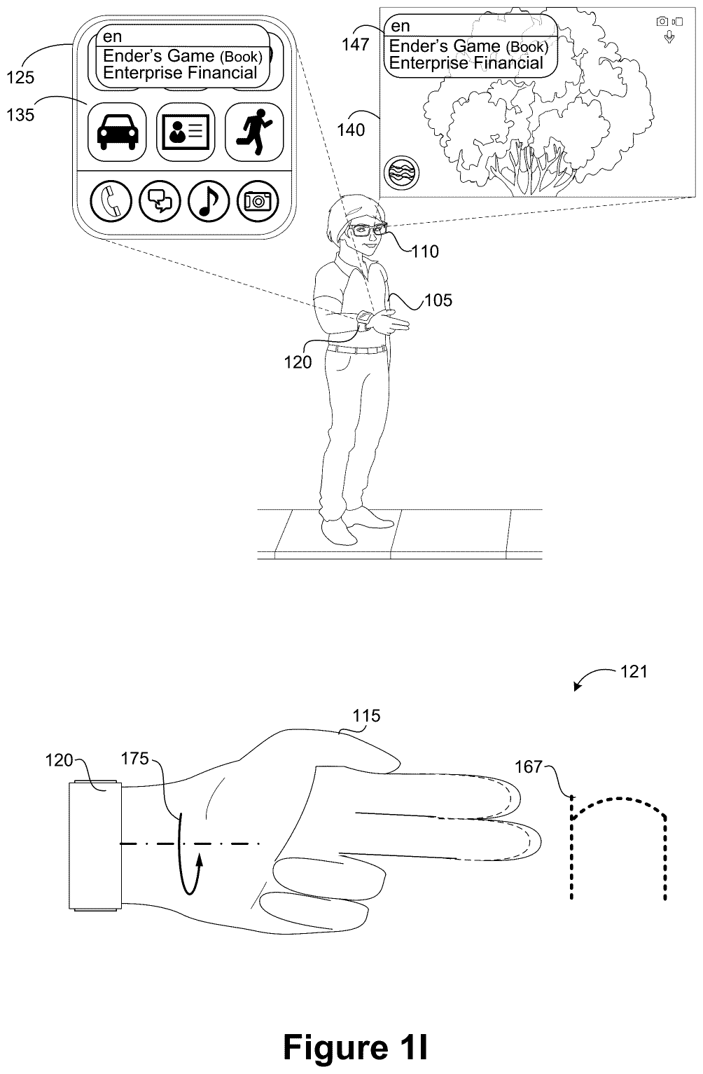

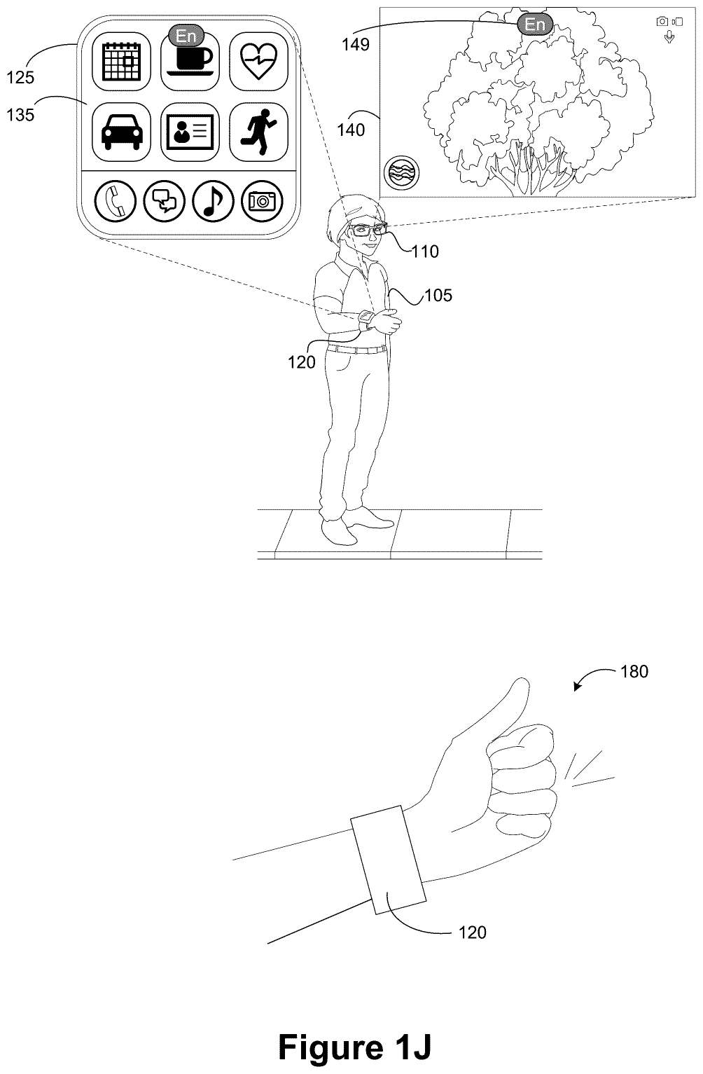

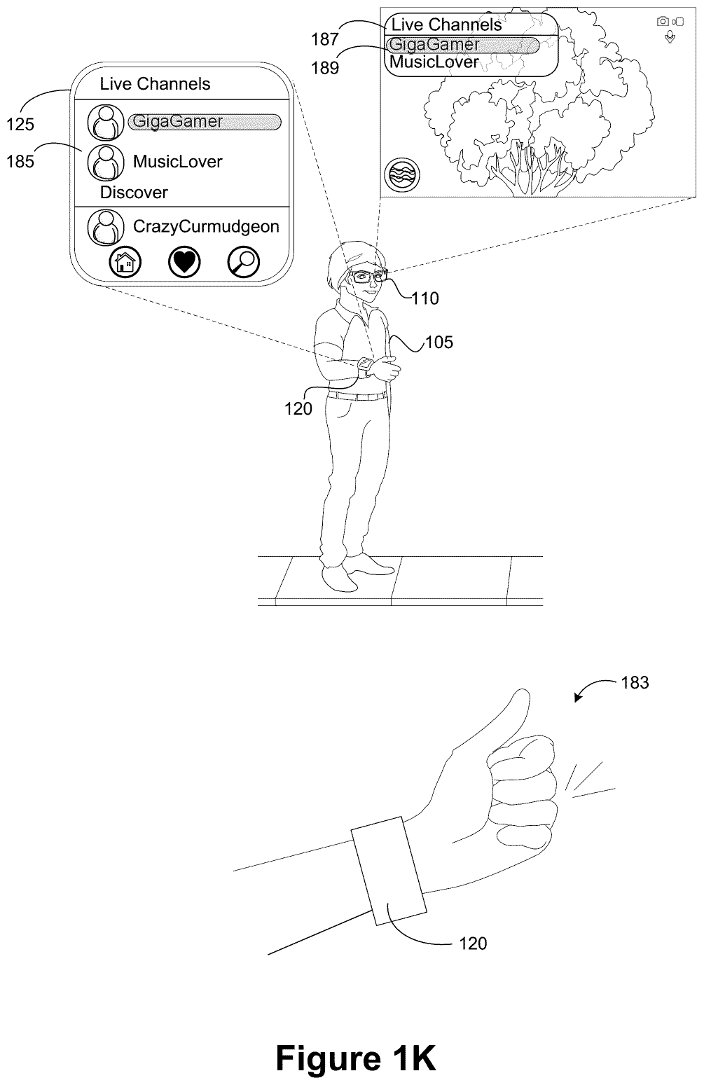

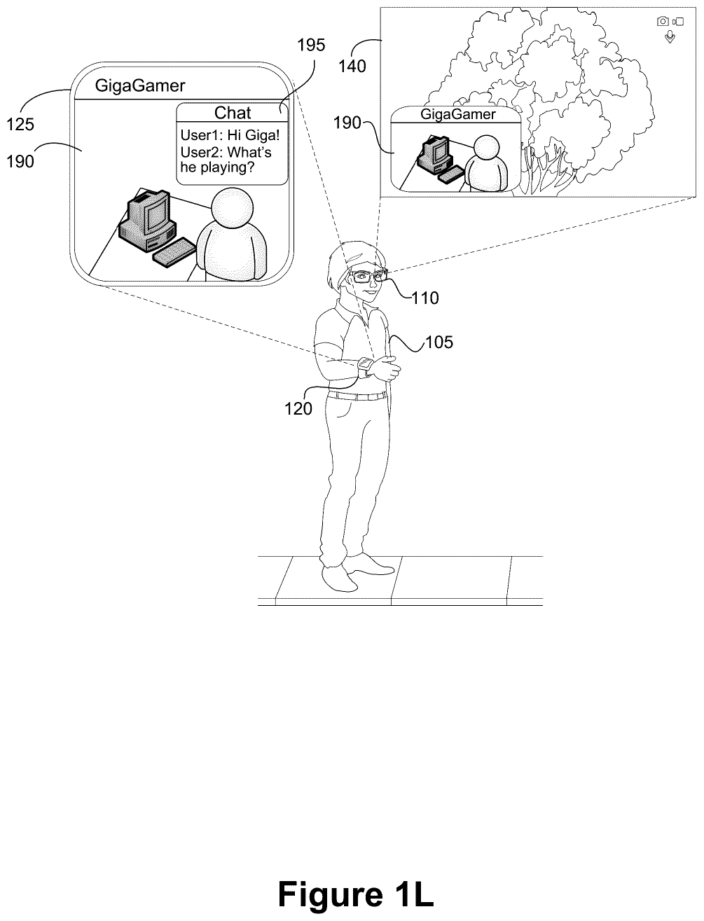

FIGS. 1A-1L illustrate example textual inputs provided by a user via a hand gesture detected by a worn wearable device, in accordance with some embodiments. More specifically, one or more wearable devices worn by a user 105, such as a head-wearable device 110 and/or a wrist-wearable device 120, detect one or more text-symbolic hand gestures performed by the user 105 and cause the performance of one or more operations associated with at least one character determined from the text-symbolic hand gestures.

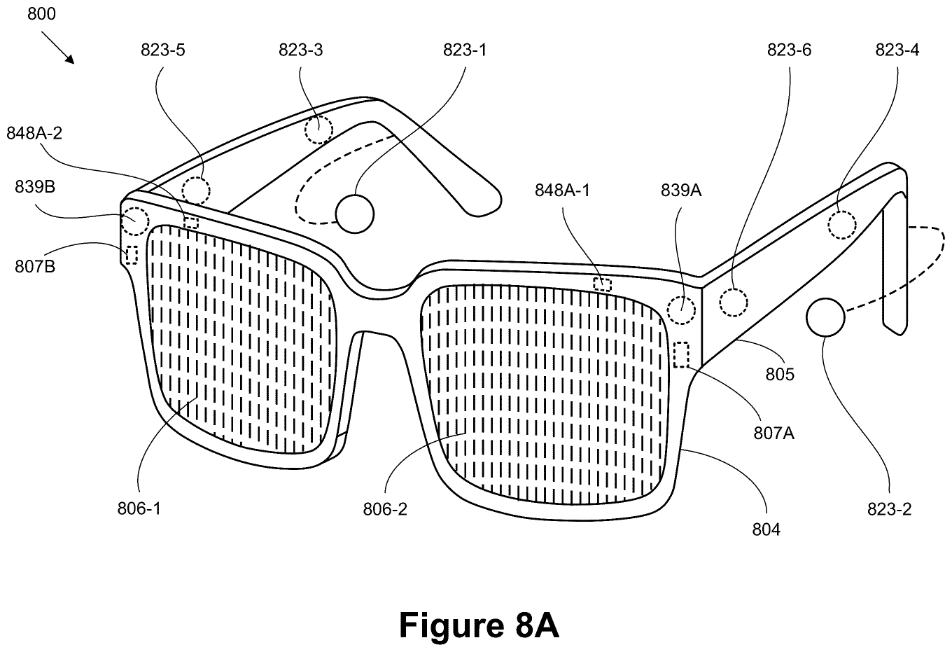

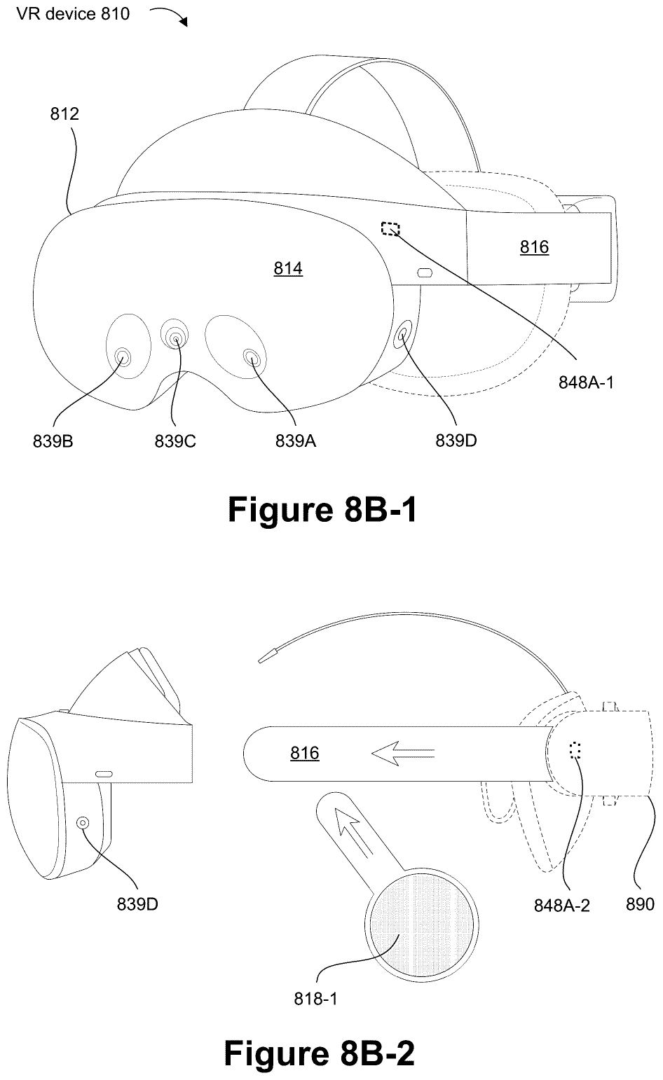

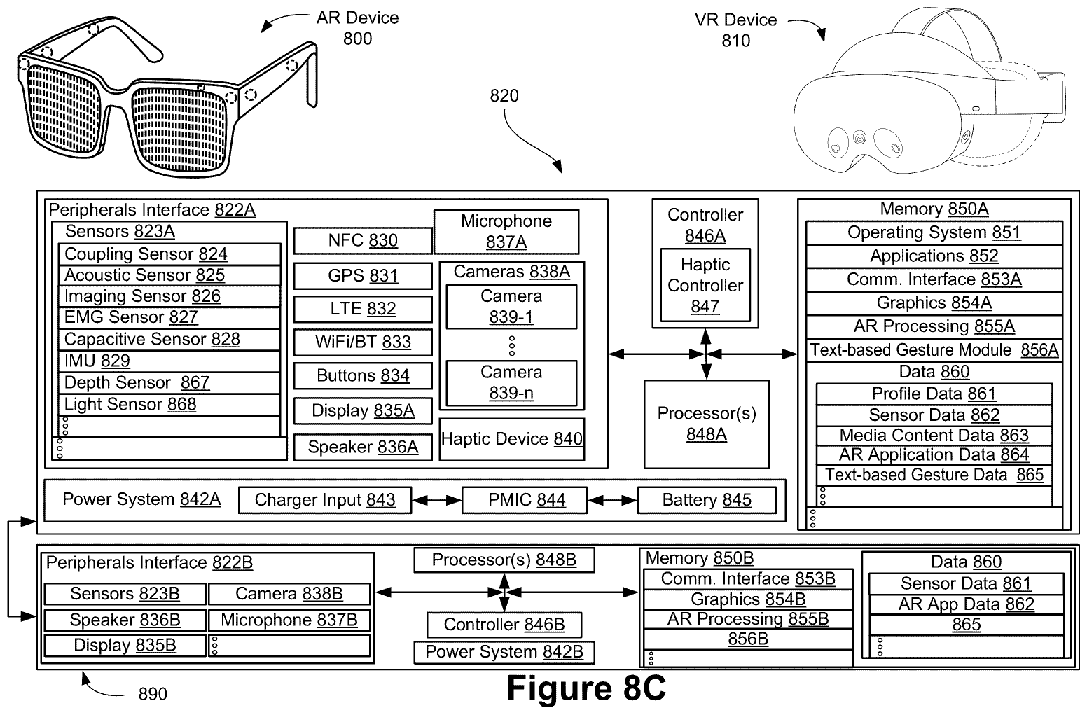

The head-wearable device 110 includes, with reference to FIGS. 8A-8B, one or more imaging devices 855, microphones 813, speakers 817, displays 140 (e.g., displays 830 including a heads-up display, a built-in or integrated monitor or screen, a projector, and/or similar device), sensors 825 (e.g., inertial measurement units (IMU) s, biometric sensors, position sensors, electromyography (EMG) sensors, and/or any other sensors), and/or one or more processors 850. In some embodiments, the one or more components of the head-wearable device 110 described above are coupled with the housing and/or lenses of the head-wearable device 110. In some embodiments, the head-wearable device 110 is a pair of smart glasses, AR goggles (with or without a heads-up display), AR glasses (with or without a heads-up display), or other head-mounted displays. The head-wearable device 110 is configured to capture image data via an imaging device 855 and/or present a representation of the image data via the display 140. In some embodiments, the display 140 is coupled with one or both of the lenses of the head-wearable device 110. In some embodiments, image data presented by the display 140 is presented in conjunction with the field of view of the user 105. Alternatively or additionally, in some embodiments, the image data is overlayed over a portion of the field of view of the user 105 (e.g., as an overlay over one or more real-world objects or the physical environment). In addition, in some embodiments, the head-wearable device 110 is configured to capture audio data via an microphone 813 and/or present a representation of the audio data via speakers 817. The head-wearable device 110 can communicatively couple with one or more of a wrist-wearable device 120, portable computing unit, and/or an intermediary device (e.g., via a Bluetooth connection between the two or more respective devices, and/or the two or more respective devices can also be connected to another intermediary device such as a smartphone that provides instructions and data to and between the two devices).

In some embodiments, the wrist-wearable device 120 includes one or more displays 125 (e.g., an interface 820 (FIG. 8A), such as a touch screen), speakers, microphones, and sensors 825, and/or one or more processors 850. In some embodiments, the one or more components of the wrist-wearable device 120 described above are coupled with a wrist-wearable structure (e.g., a band portion) of the wrist-wearable device 120, housed within a capsule portion of the wrist-wearable device 120, or a combination of the wrist-wearable structure and the capsule portion. As described above, in some embodiments, the wrist-wearable device 120 is communicatively coupled with the head-wearable device 110 (e.g., by way of a Bluetooth connection between the two devices). In some embodiments, the wrist-wearable device 120 and the head-wearable device 110 are communicatively coupled via an intermediary device (e.g., a server 870, a computer 874a, a smartphone 874b and/or other devices described below in reference to FIG. 8A) that is configured to control the wrist-wearable and head-wearable devices 120 and 110.

As shown in FIG. 1A, while the user 105 wears the head-wearable device 110 and the wrist-wearable device, an in-air hand gesture 117 is performed by the user's hand 115 (e.g., a thumb tap to a portion of their index finger). The in-air hand gesture 117 is performed while the head-wearable device 110 and the wrist-wearable device 120 are in a standby and/or wake mode (e.g., an energy saving state in which a device is active without performing operations that would deplete the devices battery power). For example, in FIG. 1A, the wrist-wearable device 120 presents, via its display 125, a wake screen user interface 130 that displays the current time, and the head-wearable device 110 operates in a pass-through mode in which the display 140 does not present information (e.g., operates as a lens). The in-air gesture (and other hand gestures described herein) is detected based on image data captured by the head-wearable device 110 and/or sensor data captured by the head-wearable device 110 and/or the wrist-wearable device 120. For example, neuromuscular signals sensed by one or more EMG sensors and/or force/acceleration data sensed by one or more IMU sensors of the wrist-wearable device 120 can be used to detect performed (or intended to be performed) hand gestures. The in-air hand gesture 117 can be detected by the wrist-wearable device 120 and/or the head-wearable device 110 individually or together. In some embodiments, the wrist-wearable device 120 detects the in-air gesture and provides instructions to activate the head-wearable device 110 and/or the head-wearable device 110 detects the in-air gesture and provides instructions to activate the wrist-wearable device 120.

The head-wearable device 110 and the wrist-wearable device 120, in response to the detected in-air gesture 117, transition from a standby or wake mode to an active state. For example, the wrist-wearable device 120 no longer presents the wake screen user interface 130 and presents a home screen user interface 135. The home screen user interface 135 can include one or more applications, such as a calling or phone application, a messaging application, a music application, a fitness application, etc. Each application is selectable using one or more in-air hand gestures. The detectable in-air hand gestures, as described herein, allow the user 105 to initiate one or more applications and/or perform one or more operations on a wearable device without having to look at the presented information.

The head-wearable device 110 can, in response to the detected in-air gesture 117, present information via its display 140. The information presented by the head-wearable device 110 can include user interfaces, user interface elements, notification icons, etc. In some embodiments, the prevent obstructing the user 105's field of view, the head-wearable device 110 may present information on a portion of the display 140. For example, as shown in FIG. 1B, the head-wearable device 110 displays a user interface element 145 notifying the user 105 that a digital assistant is active (e.g., for receiving instructions or inputs from the user 105).

The head-wearable device 110 and/or the wrist-wearable device 120 are configured to hand gestures performed in three dimensions. For example, the wrist-wearable device 120 and the head-wearable device 110 can detect the user 105's hand 115 movements in a x, y, and/or z direction. As described below, the user 105 is able to hand write a gesture (e.g., referred to as a text-symbolic hand gesture) to provide an input at the wrist-wearable device 120 and/or head-wearable device 110.

Turning to FIG. 1C, the user 105 performs a first text-symbolic hand gesture 117 (e.g., a hand drawn “F” 150). The wrist-wearable device 120 and/or the head-wearable device 110 detect the first text-symbolic hand gesture 117 and determine whether the first text-symbolic hand gesture 117 is associated with a character. The wrist-wearable device 120 and/or the head-wearable device 110, in response to determining that the first text-symbolic hand gesture 117 is associated with a character, also determine a predicted user input based on the character. The wrist-wearable device 120 and/or the head-wearable device 110 cause a communicative coupled display to present the character and the predicted user input. The predicted user inputs can be suggested autofill entries be based on the number of characters entered, the contacts on the user's communicatively coupled electronic devices, applications on the user's communicatively coupled electronic devices, the user's search history, the user's location (e.g., nearby stores or popular attractions) and/or public search recommendations (e.g., most publicly searched criteria). For example, as shown in FIG. 1C, the wrist-wearable device 120 and the head-wearable device 110 presents, via their respective displays, the character “F” and two predicted user inputs (e.g., “Frank Joe” the user's contact and “Facebook” an application on the user's devices).

In some embodiments, the determined characters and predicted user inputs are presented in an user interface element 147. In some embodiments, the user interface element 147 can be part of a search bar and/or an application. Alternatively or in addition, in some embodiments, the determined characters and predicted user inputs are presented in a user interface, such as a messaging application, we browser, social media application, etc. While the wrist-wearable device 120 and/or the head-wearable device 110 detect a text-symbolic hand gesture and/or determine a character and/or predicted user input based on the text-symbolic hand gesture, the wrist-wearable device 120 and/or the head-wearable device 110 can present the user interface element 145 notifying the user 105 that the digital assistant is active.

FIG. 1D shows the user 105 performing a second text-symbolic hand gesture 119 (e.g., a hand drawn “e” 155). The wrist-wearable device 120 and/or the head-wearable device 110 detect the second text-symbolic hand gesture 119 and determine whether the second text-symbolic hand gesture 119 is also associated with another character. In accordance with a determination that the second text-symbolic hand gesture 119 is associated with another character (e.g., the same or a distance character), the wrist-wearable device 120 and/or the head-wearable device 110 determine whether the other character is a linking or non-linking character. A linking character is a character that connects with a previous character to form a word, abbreviation, acronym, etc. Alternatively, a non-linking character is a character that does not connect with the previous character such that at least two distinct words, abbreviations, acronyms, etc. are formed. In some embodiments, a character is determined to be a non-linking character based on previously determined characters (e.g., based on a flow of a sentence, paragraph, etc.; based on completed words; based on entries with clearly defined starting and ending points (e.g., words, abbreviations, acronyms, etc. with no possible continuation or extension); etc.), the detected text-symbolic hand gestures (e.g., uppercase characters, lowercase characters, etc.), and/or other detected hand gestures (e.g., gestures performed prior to a text-symbolic hand gesture to indicate a space or break between words or other characters).

The wrist-wearable device 120 and/or the head-wearable device 110, in response to determining that the other character is a linking character, forms a set of characters (e.g., including the character and the other character) and updates the predicted user input based on the set of characters. Alternatively, the wrist-wearable device 120 and/or the head-wearable device 110, in response to determining that the other character is a non-linking character, forms respective sets of characters (e.g., a first set of characters including the character and a second set of characters including the other character) and updates the predicted user input based on the respective sets of characters. The wrist-wearable device 120 and/or the head-wearable device 110, after updating the characters and the predicted user inputs, display, via a communicative coupled display, the respective sets of characters and updated predicted user inputs. For example, in response to the second text-symbolic hand gesture 119, the wrist-wearable device 120 and/or the head-wearable device 110 presents, via their respective displays, the set of characters “Fe” and two predicted user inputs (e.g., “Felix Jones” the user's contact and “Feliz Coffee” a coffee shop near the user's location).

In some embodiments, the user 105 can use one or more hand gestures to navigate through the user interfaces presented via the wrist-wearable device 120 and/or head-wearable device 110. Additionally, the user can use one or more hand gestures to navigate through the characters and/or the user predicted inputs. For example, as shown in FIG. 1E, the user 105 moves their wrist and/or hand 115 a first direction 160 to move a selection user interface element 148 from a first set of characters (e.g. characters “Fe”) to a first predicted user input (e.g., “Felix Jones”). Similarly, the user can perform another hand gesture to return to the first set of characters. For example, as shown in FIG. 1F, the user 105 moves their wrist and/or hand 115 a second direction 165 to move return to the user interface element 147 (e.g., from the first predicted user input (e.g., “Felix Jones”) to the first set of characters (e.g. characters “Fe”)).

FIG. 1G shows the user 105 navigating between different characters presented by the head-wearable device 110 and/or wrist-wearable device 120. In some embodiments, the user 105 can provide one or more gestures to move a cursor between different characters. For example, the user 105 can rotate their wrist and/or hand 115 a first direction 170 to move a cursor 171 from the end of the one or more characters to in-between the “F” character and the “e” character as shown between FIGS. 1F and 1G.

Additionally, the user 105 can perform one or more hand gestures to modify the presented characters. For example, as shown in FIG. 1H, the user performs a backward swipe gesture 157 to delete the “F” character. Although not show, the user 105 can perform additional gestures to delete or modify other characters. For example, the user 105 can perform a forward swipe gesture to forward-delete a character. Similarly, the user 105 can perform one or more gestures to underline, italicize, capitalize, bold, and/or perform other modifications to the input characters.

The wrist-wearable device 120 and/or the head-wearable device 110, in response to determining that one or more characters were deleted or modified, forms an updated set of characters and/or updates the predicted user input based on the updated set of characters. For example, in response to deletion of the “F” character, the wrist-wearable device 120 and/or the head-wearable device 110 presents, via their respective displays, the character “e” and three updated predicted user inputs (e.g., an Email application, “Elizabeth John” the user's contact, and “Email Mom” a direct operation performed with the user 105's contact).

FIG. 1I illustrates a combination of hand gesture performed by the user, in accordance with some embodiments. In particular, the user 105 rotates their wrist and/or hand 115 in a second direction 175, which when detected by the wrist-wearable device 120 and/or head-wearable device 110 moves a cursor 171 to the end of the one or more characters. Simultaneously and/or immediately after rotating their wrist and/or hand 115 in the second direction 175, the user performs a third text-symbolic hand gesture 121 (e.g., a hand drawn “n” 167). As described above with respect to the second text-symbolic hand gesture 119, the wrist-wearable device 120 and/or the head-wearable device 110 detect the third text-symbolic hand gesture 121 and determine whether the third text-symbolic hand gesture 121 is associated with a character. In accordance with a determination that the third text-symbolic hand gesture 121 is associated with an additional character (e.g., the same or a distance character), the wrist-wearable device 120 and/or the head-wearable device 110 determine whether the additional character is a linking or non-linking character.

In FIG. 1I, the additional character is determined to be a linking character and the respective set of characters are formed and the predicted user inputs are updated. For example, the respective set of characters are shown as “en” and the predicted user inputs include “Ender's Game” a book and “Enterprise Financial” an application on the user's communicatively coupled devices.

The user 105 can provide one or more hand gestures to select a predicted user input or the one or more characters based on the performed text-symbolic hand gestures. The wrist-wearable device 120 and/or the head-wearable device 110, in response to a determination that the hand gesture selects the predicted user input, provide instructions that cause the wrist-wearable device 120 and/or the head-wearable device 110 to perform an operation associated with the predicted user input. For example, a hand gesture that selects “Enterprise Financial”; causes the wrist-wearable device 120 and/or the head-wearable device to initiate the “Enterprise Financial” application. Alternatively, in some embodiments, “Enterprise Financial” can be provided as an autofill input (e.g. the user 105 is providing a contact with an application recommendation via a messaging application and can use the suggested text to autofill their response).

Alternatively, in response to a determination that the one or more hand gesture selects the character, the wrist-wearable device 120 and/or the head-wearable device 110 provides instructions that cause the wearable device to perform an operation associated with the character. For example, the characters can be designated as a shortcut for a specific application, contact, interaction, etc. For example, as shown between FIGS. 1J and 1K, the user 105 creates a first 180 to select the respective set of characters “en,” which are associated to a streaming application for the user 105 (e.g., as shown in live streaming user interface 185). In some embodiments, the user 105 can associate a single character to a particular action. For example, the user 105 can assign the character “M” to open a map application, “L” to open a message thread with a contact “Lisa,” and/or other user defined actions.

FIG. 1K illustrates an application launched in response to a hand gesture selecting a respective set of characters (e.g., “en”). As described above, in response to the user 105 selecting the respective set of characters “en,” the wrist-wearable device 120 and/or the head-wearable device 110 perform an associated action (e.g., initiate a live streaming application, as shown by the live streaming user interface 185). Further, the user 108 can provide additional gestures to select one or more user interface elements in the live streaming user interface. For example, the user 105 selects with another created fist 183 a first user interface element (highlighted with user interface element 189).

FIG. 1L illustrates the launched live streaming application at the wrist-wearable device 120 and the head-wearable device, in accordance with some embodiments. For example, the wrist-wearable device 120 displays a live feed of a streamer “GigaGamer” in live feed user interface 190. The live stream user interface 190 can include a chat 195 including one or more messages provided by viewers of the live stream. Similarly, the head-wearable device 110 can present the live stream via its display 140. In some embodiments, the live stream is adjusted to be displayed by the head-wearable device 110 without obstructing the user 105's field of view.

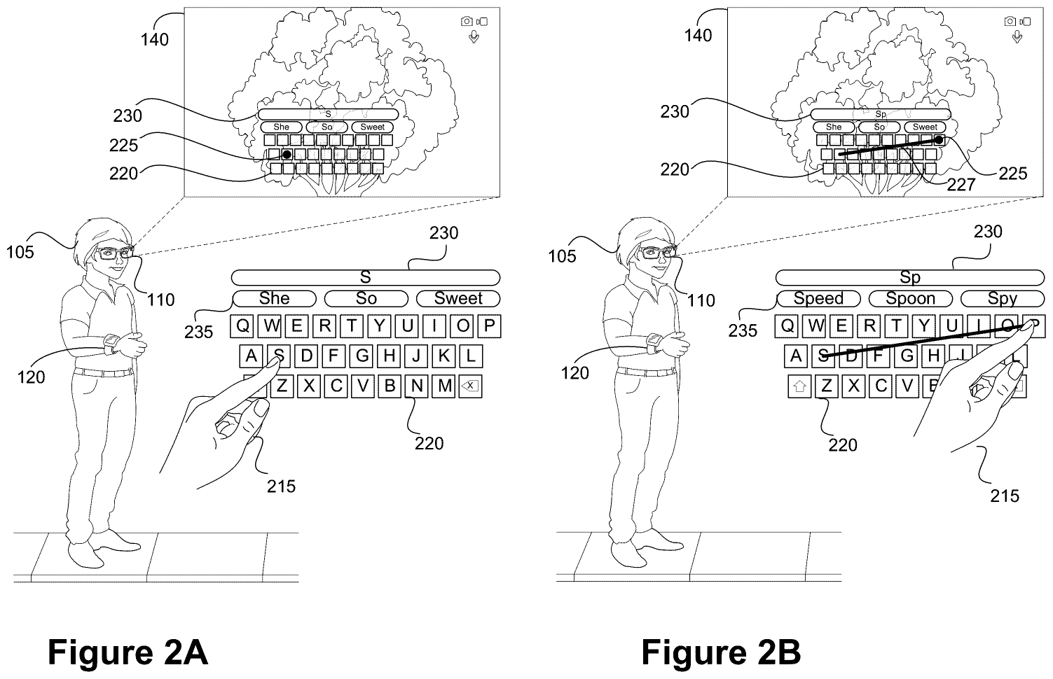

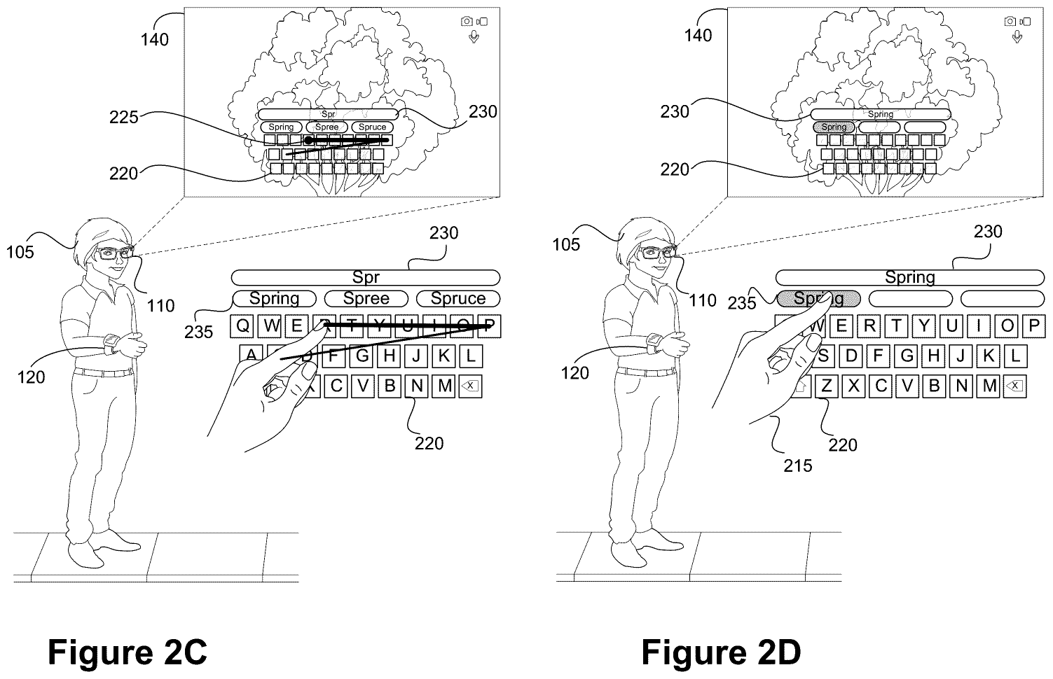

FIGS. 2A-2D illustrate an example of providing a text-symbolic hand gesture, in accordance with some embodiments. In some embodiments, the user 105 can provide text-symbolic hand gesture via a virtual keyboard 220 presented by a display 140 a head-wearable device 110. In some embodiments, the virtual keyboard 220 is presented in response to an in-air hand gesture (e.g., a fist or finger taps) performed by the user 105 and detected by a wrist-wearable device 120 and/or the head-wearable device 110.

In some embodiments, the user 105 can individually select keys on the virtual keyboard 220 to provide a text-symbolic hand gesture. For example, in FIG. 2A, the wrist-wearable device 120 and/or the head-wearable device 110 detect, based on image data and/or sensor data captured by the wrist-wearable device 120 and/or the head-wearable device 110, the user 105's hand 215 selecting the letter “S” (as shown by marker 225). Similar to FIGS. 1A-1L, the wrist-wearable device 120 and/or the head-wearable device 110, in response to detecting a text-symbolic hand gesture (e.g., selection of the letter “S”) and determining that the text-symbolic hand gesture is associated with a character, determine one or more predicted user inputs. Further, the wrist-wearable device 120 and the head-wearable device 110 present the character associated with the text-symbolic hand gesture and the one or more predicted user inputs based on the character. For example, as shown in FIG. 2A, the letter “S” is presented to the user 105 via a text input user interface element 230, and the one or more predicted user inputs based on the letter “S” (e.g., She, So, and Sweet) are presented via respective user interface elements 235.

In FIG. 2B, the user performs a “swipe” gesture which is a continuation of the previously performed text-symbolic hand gesture. More specifically, the user 105 maintains the initial input and drags the input to a subsequent character. For example, the user 105 initially selects the letter “S” with their hand 215 and drags their finger to the next desired letter “p.” The wrist-wearable device 120 and/or the head-wearable device 110 detect the user's continuous hand gesture as a text-symbolic hand gesture that is associated with one or more characters. The text input user interface element 230 and/or the respective user interface elements 235 are updated based on the text-symbolic hand gesture. In particular, the text input user interface element 230 includes “Sp,” and the respective user interface elements 235 is updated to include predicted user inputs based on “Sp” (e.g., Speed, Spoon, Spy).

The wrist-wearable device 120 and/or the head-wearable device 110 can provide a visual indicator to the user (e.g., trailing line indicator 227) to show the gesture performed by the user 105. The trailing line indicator 227 has a starting point from the initial position of the marker 225 to its updated position.

In FIG. 2C, the user continues the swipe gesture. More specifically, the user 105 maintains the input and further drags the input to another character. For example, the user 105 further drags their finger from the letter “p” to the letter “r.” The wrist-wearable device 120 and/or the head-wearable device 110 update the characters and the predicted user inputs based on the continuous text-symbolic hand gesture (e.g., the continuous swipe gesture). In particular, the text input user interface element 230 includes “Spr,” and the respective user interface elements 235 is updated to include predicted user inputs based on “Sp” (e.g., Spring, Spree, Spruce).

The wrist-wearable device 120 and/or the head-wearable device 110 also update the trailing line indicator 227 to show the gesture performed by the user 105. The trailing line indicator 227 shows the user's movement from the letter “S,” to the letter “p,” and to the letter “r” (the current position of the marker 225).

In FIG. 2D, the wrist-wearable device 120 and/or the head-wearable device 110 detect a hand gesture selecting a predicted user input (e.g. “Spring”). The wrist-wearable device 120 and/or the head-wearable device 110 perform an operation associated with the predicted user input. For example, in FIG. 2D, the wrist-wearable device 120 and/or the head-wearable device 110 complete the word “Spring” in the text input user interface element 230.

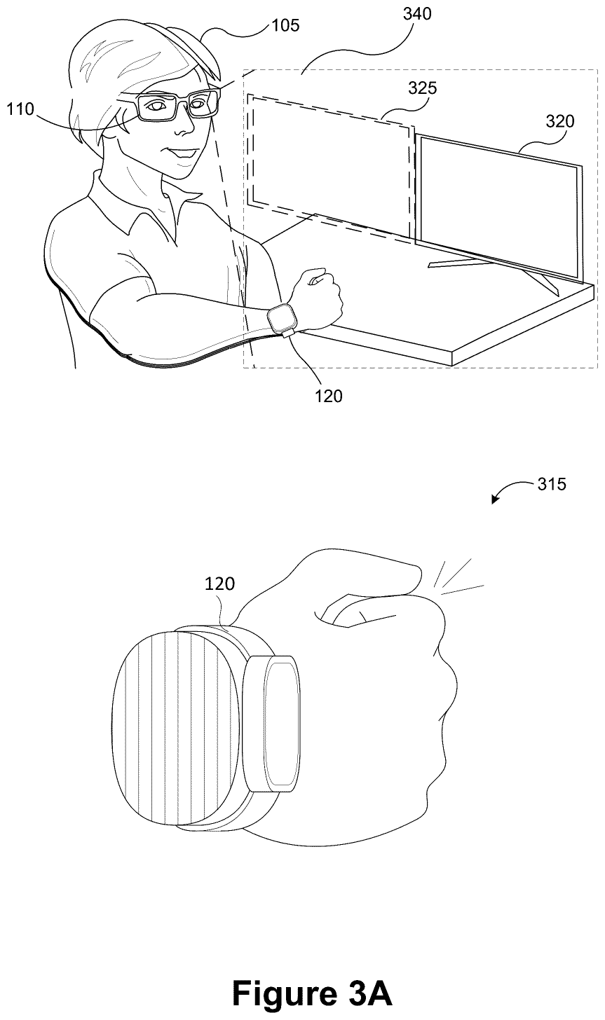

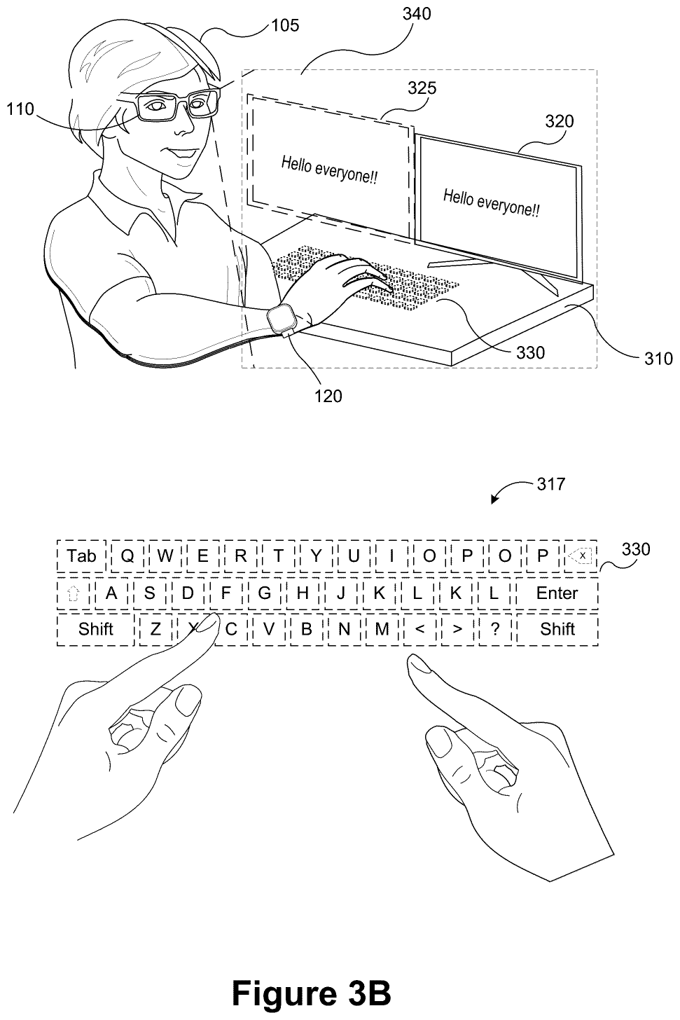

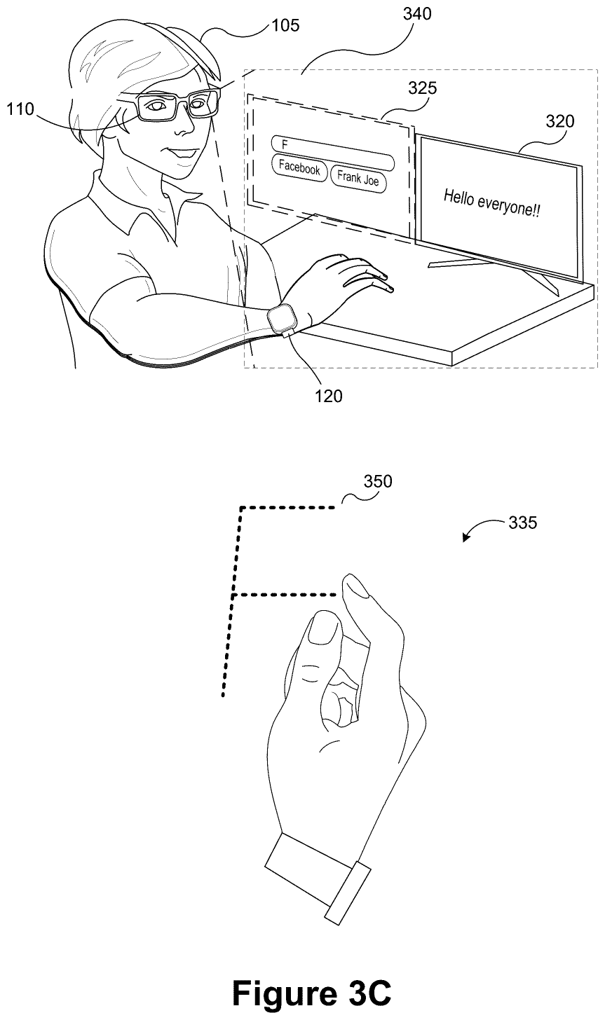

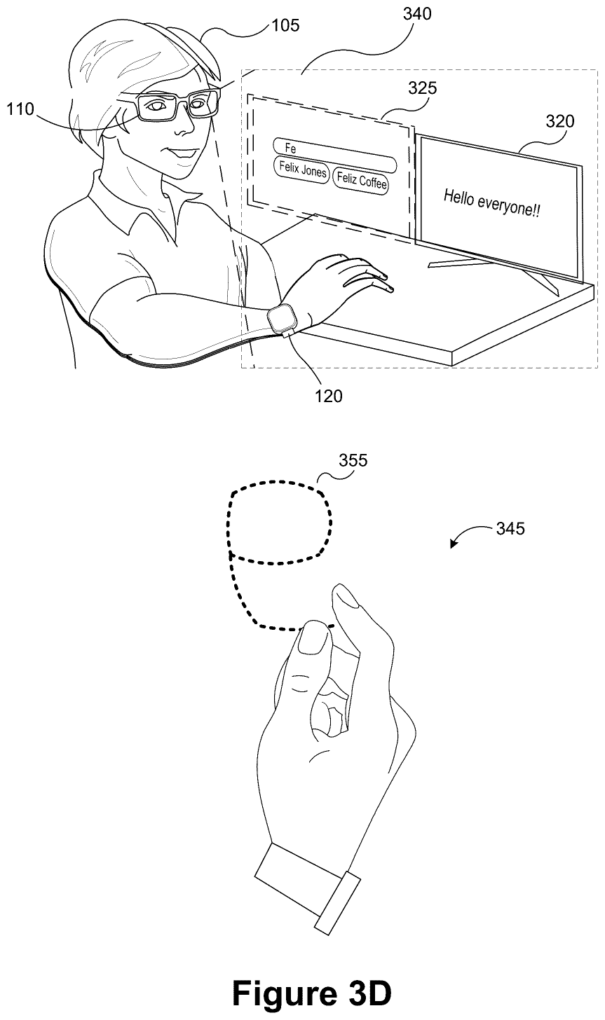

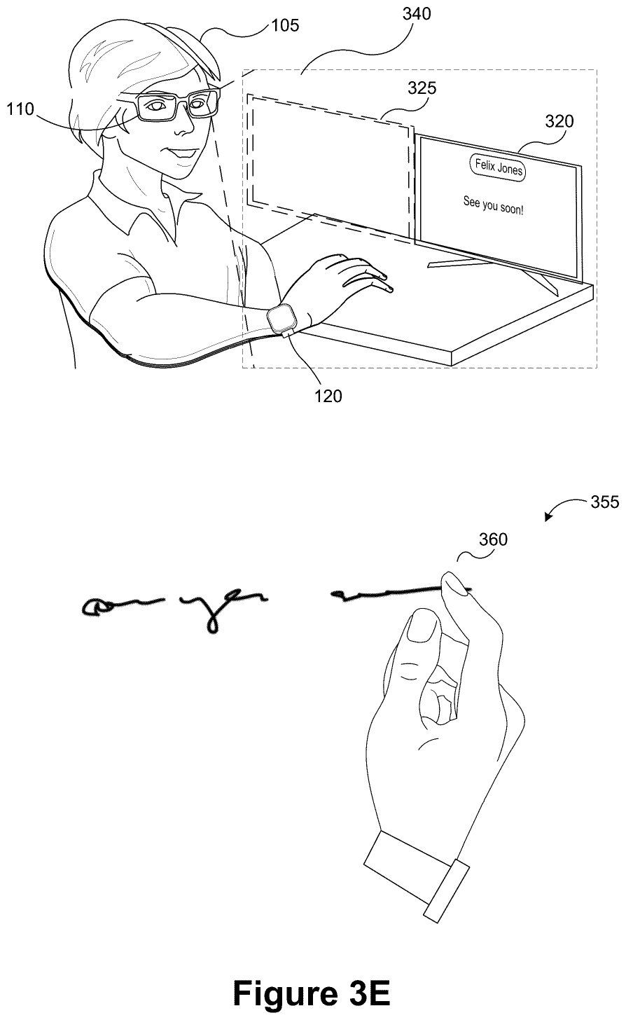

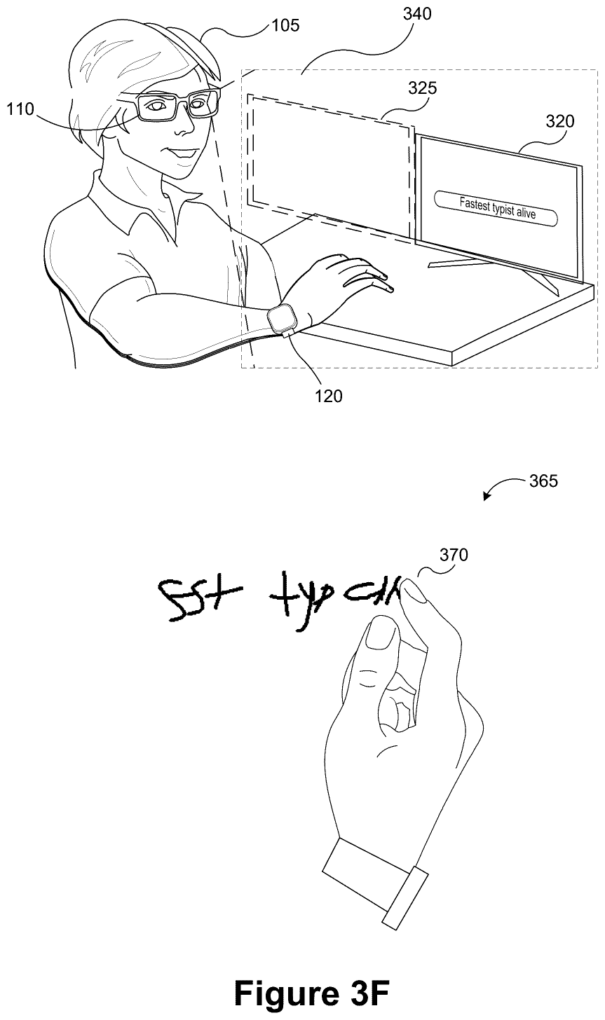

FIGS. 3A-3F illustrate different examples of providing text-symbolic hand gestures, in accordance with some embodiments. In some embodiments, the user 105 can use a number of text-symbolic hand gestures to provide textual inputs. For example, the user 105 can use a surface typing gesture (as shown in FIG. 3B), a handwriting gesture (as shown in FIGS. 3C-3D), a user specific shorthand gesture (as shown in FIG. 3E), and a user-device learned shorthand gesture (FIG. 3F).

Turning to FIG. 3A, the user 105 performs in-air hand gesture 315 (e.g., a thumb tap to a portion of their index finger), which, when detected by the wrist-wearable device 120 and/or head-wearable device 110, activate the wrist-wearable device 120 and/or head-wearable device 110 for receiving one or more text-symbolic hand gestures (e.g., transition a wearable device from a standby mode to an active state). Alternatively, in some embodiments, the user 105 can provide a text-symbolic hand gesture that causes the wrist-wearable device 120 and/or head-wearable device 110 to transition into an active mode.

In some embodiments, the wrist-wearable device 120 and/or head-wearable device 110 are communicatively coupled with a display 320 cause the display 320 to present information presented at the wrist-wearable device 120 and/or head-wearable device 110. In some embodiments, the head-wearable device 110 can present and/or project a virtual display 325 (as shown in field of view 340). The virtual display 325 can present information presented at the wrist-wearable device 120 and/or head-wearable device 110. In some embodiments, the virtual display 325 can operate as a duplicate display and/or an extended display of display 320.

In FIG. 3B, in response to the in-air hand gesture 315, the head-wearable device 110 presents a surface projected virtual keyboard 330 over a surface 310. The user 105 can provide one or more text-symbolic hand gestures 317 via the surface projected virtual keyboard 330 that are detected by the wrist-wearable device 120 and/or the head-wearable device 110. In particular, image and/or sensor data captured by the wrist-wearable device 120 and/or the head-wearable device 110 is used to determine selection of one or more virtual keys on the surface projected virtual keyboard 330. In FIG. 3B, the user 105 provides text-symbolic hand gestures 317 to type out the message “Hello everyone!!” The wrist-wearable device 120 and/or the head-wearable device 110, in response to detecting and determining that the text-symbolic hand gestures 317 are associated with characters, present the associated characters on the display 320 and virtual display 325.

In FIG. 3C, the user 105 provides one or more text-symbolic hand gestures 335 via a handwriting gesture. For example, as described above in reference to FIGS. 1A-1L, the user 105 performs a hand drawn “F” 350 which is detected by the head-wearable device 110 and/or the wrist-wearable device 120. The head-wearable device 110 and/or the wrist-wearable device 120, in response to detecting and determining that the user drew out the letter “F,” present the letter “F” along with one or more predicted user inputs (e.g., “Facebook” and “Frank Joe”). The head-wearable device 110 and/or the wrist-wearable device 120 can cause the letter “F” and the one or more predicted user inputs to be displayed via the display 320, the virtual display 325, their respective displays, and/or another communicatively coupled display.

In FIG. 3D, the user 105 provides a subsequent hand drawn gesture 345. For example, the user 105 performs a hand drawn “e” 355 which is detected by the head-wearable device 110 and/or the wrist-wearable device 120. The head-wearable device 110 and/or the wrist-wearable device 120, in response to detecting and determining that the user 105 drew out the letter “e,” present the letters “Fe” along with updated predicted user inputs (e.g., “Felix Jones” and “Feliz Coffee”). The determination of the updated predicted user inputs is provided above in reference to FIGS. 1A-1L. The head-wearable device 110 and/or the wrist-wearable device 120 cause the letters “Fe” and the one or more updated predicted user inputs to be displayed via the display 320, the virtual display 325, their respective displays, and/or another communicatively coupled display.

In FIG. 3E, the user 105 selects the updated predicted user input corresponding to “Felix Jones.” Selection of “Felix Jones” causes the head-wearable device 110 and/or the wrist-wearable device 120 to present a user interface that includes one or more correspondences between the user 105 and Felix Jones (e.g., a messaging user interface). In FIG. 3E, the text-symbolic hand gesture 355 performed by the user is a user specific shorthand gesture 360. In particular, each user 105 has their specific handwriting, and the head-wearable device 110 and/or the wrist-wearable device 120 learn, over time, the user's specific style. In this way, over time, the user is able to use their normal handwriting style to provide textual inputs via the head-wearable device 110 and/or the wrist-wearable device 120. A user's handwriting that is not normally legible to others can be detected and determined the head-wearable device 110 and/or the wrist-wearable device 120. For example, in FIG. 3E, the user specific shorthand gesture 360 writes out the sentence “See you soon!” The head-wearable device 110 and/or the wrist-wearable device 120, after detecting and determining the characters associated with the user specific shorthand gesture 360, present the determined characters on the display 320. In some embodiments, the head-wearable device 110 and/or the wrist-wearable device 120 automatically share the determined characters. For example, the head-wearable device 110 and/or the wrist-wearable device 120 can automatically send the message “See you soon!” to Felix Jones (an ongoing interaction of the user 105).

Further, as the user 105 becomes more accustomed to providing handwritten gestures using the wrist-wearable device 120 and/or the head-wearable device 110, the user's handwriting while using the wrist-wearable device 120 and/or the head-wearable device 110 can devolve over time (e.g., become customized shorthand or quick notes that are only understood by the user). The wrist-wearable device 120 and/or the head-wearable device 110 can collect user data over time that can be used to interpret the user's devolved handwriting (e.g., detect and determine characters associated with the devolved handwriting). The devolved handwriting also helps improve a user's overall typing speed. Specifically, the user 105 can write mutated and optimized characters (such as smaller, quicker, bigrams) that are detected by the wearable deices and used to provide textual inputs.

In FIG. 3F, the text-symbolic hand gesture 365 performed by the user is a user-device learned shorthand gesture 370. A user-device learned shorthand gesture is a co-created character or symbol defined by the user 105 and the wearable deice (e.g., character mapping by the wrist-wearable device 120 and/or head-wearable device 110). The co-created gesture or symbol is unique to the user and the wearable device (or profile associated with the wearable device) and can only be interpreted by the user operating the wearable device. (e.g., similar to a Stenotype). As shown in FIG. 3F, the user-device learned shorthand gesture 370 does not write out a complete sentence understood by another person. The head-wearable device 110 and/or the wrist-wearable device 120, after detecting the user-device learned shorthand gesture 370, determine one or more characters associated with the user-device learned shorthand gesture 370 and present the determined characters on the display 320 (e.g., “Fastest typist alive”). As described above, the head-wearable device 110 and/or the wrist-wearable device 120 can automatically share the determined characters or present the determined characters for the user to review.

The user-device learned shorthand gestures allow a user 105 to further increase their typing speed by providing tools that allow the user to generate their own customized symbols to represent complete words, phrases, acronyms, abbreviations, etc. The user-device learned shorthand gestures are learned over time and provide greater flexibility to the user 105 the more they use the wearable devices.

While the primary example herein is an in-air gesture, the disclosure is not limited to those in-air hand gestures (also referred to herein as hand gestures for simplicity), as other gestures that do not contact a wearable device (e.g., the head-wearable device 110 and/or the wrist-wearable device 120) or other communicatively coupled device are also contemplated, including the surface-contact gestures. Further, hand gestures can be associated with one or more commands other than a text-symbolic gesture, such as other application-control gestures (e.g., gestures used to control or provide one or more inputs at an application, such as navigating an application UI, controlling and/or interacting with an virtual object; a user avatar; and/or other users of the application; etc.), position-control gestures (e.g., gestures used to control a user's position in an AR environment and/or adjust a user's view within an application), and/or device-control gestures (e.g., gestures used to control or provide one or more inputs at an electronic device, such as navigating a device UI, controlling an imaging device, activating a speaker, etc.).

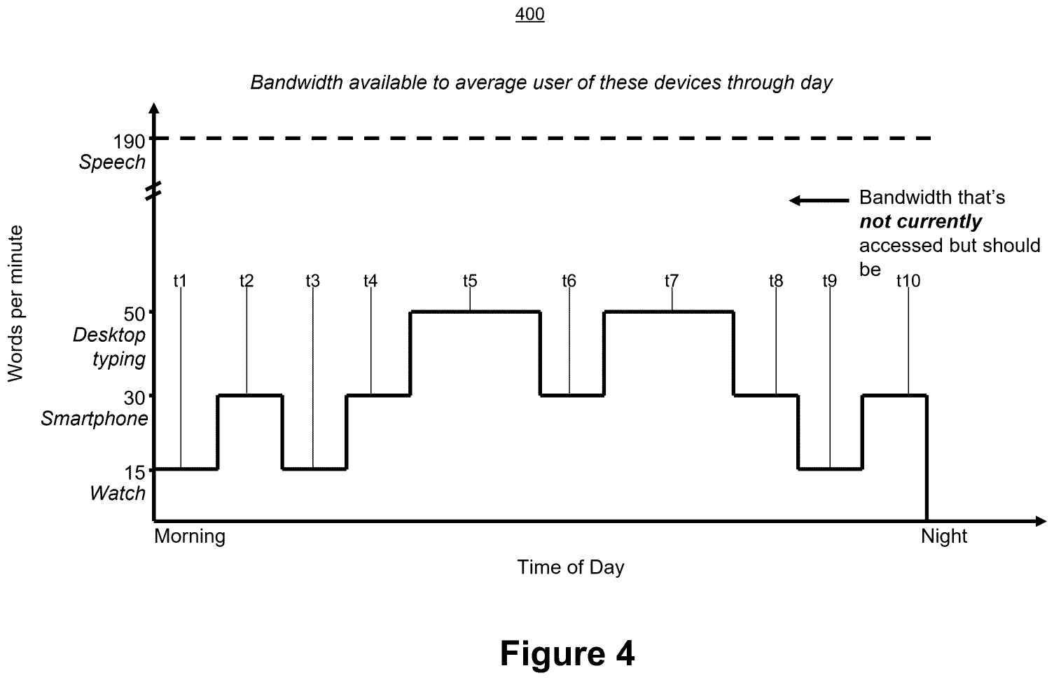

FIG. 4 illustrates electronic device availability through a user's day. In particular, bandwidth plot 400 shows a user's ability to provide textual inputs throughout a day without using the systems and methods disclosed above in reference to FIGS. 1A-3F. As shown in bandwidth plot 400, in the morning, a user can have a reduced ability to provide textual input. For example, at a first point in time (t1), the user may be in bed without their phone and use a smartwatch to type at a rate of at least 15 words per minute (WPM). At a second point in time (t2), the user can grab their phone which can increases their typing rate to at least 30 WPM. At the third point in time (t3), the user can be on their commute (e.g., biking, driving, etc.) and have reduced access to their phone. At a fourth point in time (t4), the user arrives at their destination and regains access to their phone which increases their typing rate to 30 WPM. At a fifth point in time (t5), the user is at their desk and has access to a computer. While using their computer, the user can have a typing rate of at least 50 WPM. The user's typing rate can fluctuate throughout the day as they gain and lose access to particular devices. While existing electronic devices can increase a user's typing rate, the rate at which words can be communicated do not compare to the average rate at which people speak (e.g., 190 WPM).

The systems and methods disclosed herein are designed to bridge the gap between the typing bandwidth available using existing devices and the speed at which people speak. In particular, the systems and methods disclosed herein are configured to allow a user to increase their typing speed through use of wearable devices, such as a wrist-wearable device 120 and/or a head-wearable device 110. The wearable devices allow the user to gradually increase their typing speed through use of the wearable devices. Further, because the wearable devices are low friction devices, they can be used throughout the day making them available.

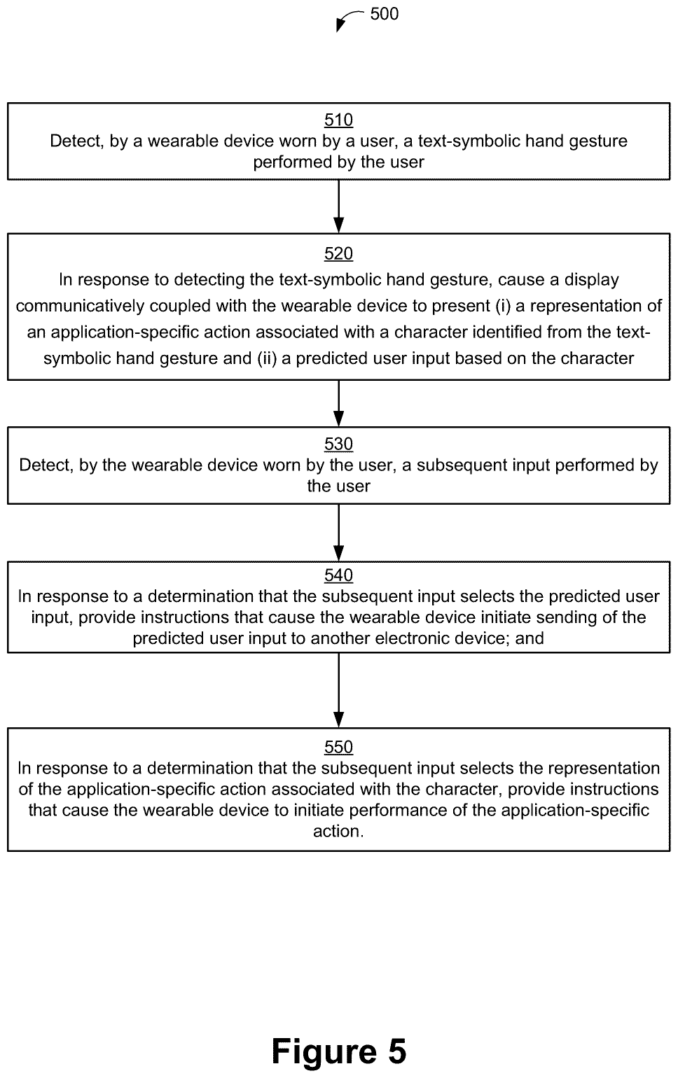

FIG. 5 illustrates a flow diagram of a method of detecting and determining one or more characters associated with a text-symbolic hand gesture performed by the user, in accordance with some embodiments. Operations (e.g., steps) of the method 500 can be performed by one or more processors (e.g., central processing unit and/or microcontroller unit; processors, e.g., processors 779 FIGS. 8A-8B) of a system 800 including a head-wearable device 110 and/or wrist-wearable device 120. In some embodiments, the head-wearable device 110 is coupled with one or more sensors (e.g., various sensors discussed in reference to FIGS. 8A-8B, such as a heart rate sensor, IMU, an EMG sensor, SpO2 sensor, altimeter, thermal sensor or thermal couple, ambient light sensor, ambient noise sensor), a display, a speaker, an imaging device (FIGS. 8A-8B; e.g., a camera), and a microphone to perform the one or more operations. At least some of the operations shown in FIG. 5 correspond to instructions stored in a computer memory or computer-readable storage medium (e.g., storage, RAM, and/or memory 860, FIGS. 8A-8B). Operations of the method 500 can be performed by the head-wearable device 110 alone or in conjunction with one or more processors and/or hardware components of another device communicatively coupled to the head-wearable device 110 (e.g., a wrist-wearable device 120, a smartphone 874b, a laptop, a tablet, etc.) and/or instructions stored in memory or computer-readable medium of the other device communicatively coupled to the head-wearable device 110. Similarly, operations of the method 500 can be performed by the wrist-wearable device 120 alone or in conjunction with one or more processors and/or hardware components of another device communicatively coupled to the wrist-wearable device 120 (e.g., the head-wearable device 110, a smartphone 874b, a laptop, a tablet, etc.) and/or instructions stored in memory or computer-readable medium of the other device communicatively coupled to the wrist-wearable device 120.

The method 500 includes detecting (510), by a wearable device worn by a user, a text-symbolic hand gesture performed by the user. In some embodiments, the text-symbolic hand gesture is a swipe typing gesture as described above in reference to FIGS. 2A-2D. In some embodiments, the text-symbolic hand gesture is a surface typing gesture as described above in reference to FIG. 3B. In some embodiments, the text-symbolic hand gesture is handwriting gesture (e.g., in-air, surface gesture, or other gesture that does to involve contacting the wearable device). Examples of the handwriting gesture are provided above in reference to FIGS. 1A-1L and 3C-3D. In some embodiments, the handwriting gesture is user specific shorthand as described above in reference to FIG. 3E. Additionally or alternatively, in some embodiments, the handwriting gesture is a learned gesture generated by the wearable device and historic user data such that the learned gesture is specific to the user (e.g., the user-device learned shorthand gesture described above in reference to FIG. 3F). The text-symbolic hand gesture can be detected based on image data and/or computer vision (CV), sensor data (e.g., EMG sensor data), and/or a combination of computer vision and sensor data.

The method 500 can detect visually imperceptible hand gestures (e.g., visually imperceptible text-symbolic hand gestures). By detecting visually imperceptible hand gestures, the method 500 improves the availability of a wearable device. In some embodiments, the method 500 includes availability in target contexts of at least 95%, meaning that the user will be able to provide inputs 95% of the time that the wearable device is used. Availability in target contexts is defined as percent of time the user has access to private, high bandwidth text inputs (e.g., such that they can provide textual inputs subtlety, comfortably, privacy, etc.).

The method 500 includes, in response to detecting the text-symbolic hand gesture, causing (520) a display communicatively coupled with the wearable device to present a representation of an application-specific action associated with a character identified from the text-symbolic hand gesture and a predicted user input based on the character. In some embodiments, the determination that the text-symbolic hand gesture is associated with a character includes comparing image and/or sensor data captured by the wearable device (e.g., the head-wearable device 110 and the wrist-wearable device 120) with stored character data, including predefined character data, user specific character data, and user-device specific character data, and selecting, based on the comparison of the image and/or sensor data with a the stored character data, the character. In some embodiments, the character determined based on the text-symbolic hand gesture has a character error rate (CER) less that 10 percent. In some embodiments, the CER of a determined character is less than 7%, 3%, or 2%.

For example, the determination that the text-symbolic hand gesture is associated with the character includes interpreting the user specific shorthand based on a comparison of historical user data with the hand gesture performed by the user. As described above, in reference to FIGS. 3E, a user's handwriting can devolve over time (e.g., become customized shorthand or quick notes that are not legible by others), and user data collected over time can be used to interpret the devolved handwriting (e.g., one or more characters associated with the handwriting). Similarly, the determination that the text-symbolic hand gesture is associated with the character includes interpreting the user-device learned shorthand gesture based on a comparison of user-device specific character data with the hand gesture performed by the user. As described above in reference to FIG. 3F, the user-device learned shorthand gesture is a co-created gesture (e.g., created by the user and the wearable device) that is associated with a new symbol (e.g., character mapped and defined by the user-device specific character data). The user-device learned shorthand gesture is unique to the user and the wearable device (or profile associated with the wearable device) and can only be interpreted by the user operating the wearable device (e.g., similar to a Stenotype).

The method 500 includes detecting (530), by the wearable device worn by the user, a subsequent input performed by the user. A subsequent input can be an additional hand gesture. As described above, respective hand gestures can be detected based on image data captured by the wearable device, detected based on sensor data captured by the wearable device and/or detected based on sensor data and image data captured by the wearable device. In some embodiments, the subsequent input is a voice command, an input at the wearable device (e.g., input at a touchscreen of a wrist-wearable device), and/or an input at another device communicatively coupled with the wearable device.

The method 500 further includes, in response to a determination that the subsequent input selects the predicted user input, providing (540) instructions that cause the wearable device initiate sending of the predicted user input to another electronic device. Initiating sending of the predicted user input to another electronic device can include causing an application on the wearable device to send the predicted user input to the other electronic device, causing a portion of a user interface presented by the wearable device to be populated with the predicted user input for review before sending, causing the predicted user input to be shared with another electronic device distinct from the wearable device, etc. For example, the predicted user can be sent a text message to another electronic device (e.g., a quick response with one or more contacts) or the user can have a message thread opened or participate in a live chat and selection of the predicted user input provides the predicted user input as a message shared with other electronic devices.

The method 500 also includes, in response to a determination that the subsequent input selects the representation of the application-specific action associated with the character, providing (550) instructions that cause the wearable device to initiate performance of the application-specific action. Initiating performance of the application-specific action can include causing an application on the wearable device to open, causing a portion of a user interface of an application presented on the wearable device to be populated with a predetermined input, causing an application on the wearable device to perform an application specific operation, and causing an application to initiate an interaction with a predefined contact associated with the character. For example, the user can gesture a “W” character to open “Whatsapp” or an “M” character to open a “Music” application. In the case of causing a portion of a user interface to be presented, the user can populate the user interface (e.g., the user can provide each character to manually populate a text field or populated the text field with a predetermined input (e.g., a full word, name, phrase, etc.)).

The predicted user inputs can include one or more words, sentences, a name, a date, a time, an abbreviation, an acronym, and an application. The characters can include one or more letters, symbols, words, set of characters, etc. In some embodiments, the characters can be alphanumeric value, symbol, roman characters, characters in foreign languages, co-created characters, etc.

In some embodiments, the text-symbolic hand gesture is a first text-symbolic hand gesture and the character is a first character, and the method further includes detecting, by the wearable device worn by the user, a second text-symbolic hand gesture performed by the user. The method 500 includes, in response to detecting the second text-symbolic hand gesture and in accordance with a determination that a second character identified from the second text-symbolic hand gesture is a linking character that connects to the first character to form a set of characters, causing the display communicatively coupled with the wearable device to present (i) a representation of an application-specific action associated with the set of characters and (ii) an updated predicted user input based on the set of characters. In some embodiments, the method 500 further includes detecting, by the wearable device worn by the user, a third text-symbolic hand gesture performed by the user, and, in response to detecting the third text-symbolic hand gesture and in accordance with a determination that a third character identified from the second text-symbolic hand gesture is a non-linking character that is not connected to the first character such that the first character forms a first set of characters and the third character forms a second set of characters, causing the display communicatively coupled with the wearable device to present (i) a representation of an application-specific action associated with the first and second set of characters and (ii) an updated predicted user input based on the first and second set of characters.

In some embodiments, the method also includes detecting, by the wearable device worn by the user, another input performed by the user, and in response to a determination that the other input selects one or more sets of characters, providing instructions that cause the wearable device to perform an operation associated with the one or more sets of characters. For example, opening one or more applications, capturing an image, initiating an interaction with a contact, etc. The other input can be a hand gestures, voice command or other input detected by a wearable device.

In some embodiments, the character and/or predicted user input are determined such that the user can provide textual inputs at a rate of at least 20 words per minute. In some embodiments, the character and/or predicted user input are determined such that the user can provide textual inputs at a rate of at least 30 WPM, 50 WPM, or more.

In another embodiment, another method can include detecting, by a wearable device worn by a user, a text-symbolic hand gesture performed by the user. The other method can include, in response to a determination that the text-symbolic hand gesture is associated with a character, determining a predicted user input based on the character and causing a display, communicative coupled with the wearable device, to present the character and the predicted user input.

The other method can also include detecting, by the wearable device worn by the user, a subsequent input performed by the user. As described above, the subsequent input can be a hand gestures, voice command or other input detected by a wearable device. The other method includes, in response to a determination that the subsequent input selects the predicted user input, providing instructions that cause the wearable device to perform an operation associated with the predicted user input. In some embodiments, the operations associated with the predicted user input include causing an application on the wearable device to open (e.g., the user can type out “Whats . . . ” and the predicted user input can be “Whatsapp” such that when the predicted user input is selected, the Whatsapp application opens). In some embodiments, the operations associated with the predicted user input include causing a portion of a user interface presented by the wearable device to be populated (e.g., the user select the predicted user input to autofill or populate a text field, user interface, etc.). In some embodiments, the operations associated with the predicted user input include causing the predicted user input to be shared with another electronic device, distinct from the wearable device (e.g., a quick response with one or more contacts). For example, the user can have a message thread opened or participate in a live chat and selection of the predicted user input provides the predicted user input as a message shared with other electronic devices. In some embodiments, the operations associated with the predicted user input include causing the wearable device to initiate an interaction with a predefined contact associated with the predicted user input (e.g., the user can use the predicted user input to be selected from a list of stored contacts in an electronic device).

The other method can also include, in response to a determination that the subsequent input selects the character, providing instructions that cause the wearable device to perform an operation associated with the character. In some embodiments, the operations associated with the character include causing an application on the wearable device to open a specific application. In some embodiments, the operations associated with the character include causing a portion of a user interface presented by the wearable device to be populated. In some embodiments, the operations associated with the character include causing the wearable device to initiate an interaction with a predefined contact associated with the character (e.g., quick access to a contact).

In some embodiments, the text-symbolic hand gesture is a first text-symbolic hand gesture and the character is a first character, and the other method further includes detecting, by the wearable device worn by the user, a second text-symbolic hand gesture performed by the user. In response to a determination that the second text-symbolic hand gesture is associated with a second character and in accordance with a determination that the second character is a linking character that connects to the first character to form a set of characters, the other method includes updating the predicted user input based on the set of characters, and causing the display communicative coupled with the wearable device to present the set of characters and an updated predicted user input. In some embodiments, the other method further includes detecting, by the wearable device worn by the user, a third text-symbolic hand gesture performed by the user, and, in response to a determination that the third text-symbolic hand gesture is associated with a third character and in accordance with a determination that the third character is a non-linking character that is not connected to the first character such that the first character forms a first set of characters and the third character forms a second set of characters, updating the predicted user input based on the first and second set of characters and causing the display communicative coupled with the wearable device to present the first and second set of character and an updated predicted user input.

In some embodiments, the other method also includes detecting, by the wearable device worn by the user, another hand gesture performed by the user, and in response to a determination that the other hand gesture selects one or more sets of characters, providing instructions that cause the wearable device to perform an operation associated with the one or more sets of characters. For example, opening one or more applications, capturing an image, initiating an interaction with a contact, etc.

The above operations associated with a predicted user input and/or character are non-limiting. Any number of different operations can be associated with a character and/or predicted user input.

### Example Aspects

A few example aspects will now be briefly described.

(A1) In accordance with some embodiments, a method of detecting handwriting is disclosed. The method includes detecting, by a wearable device worn by a user, a text-symbolic hand gesture performed by the user. The method includes, in response to detecting the text-symbolic hand gesture, causing a display communicatively coupled with the wearable device to present (i) a representation of an application-specific action associated with a character identified from the text-symbolic hand gesture and (ii) a predicted user input based on the character. The method also includes detecting, by the wearable device worn by the user, a subsequent input performed by the user, and, in response to a determination that the subsequent input selects the predicted user input, providing instructions that cause the wearable device to initiate sending of the predicted user input to another electronic device. The method further includes, in response to a determination that the subsequent input selects the representation of the application-specific action associated with the character, providing instructions that cause the wearable device to initiate performance of the application-specific action.

(A2) In some embodiments of A1, initiating sending of the predicted user input to another electronic device includes one or more of (i) causing an application on the wearable device to send the predicted user input to the other electronic device, (ii) causing a portion of a user interface presented by the wearable device to be populated with the predicted user input for review before sending, and (iii) causing the predicted user input to be shared with another electronic device distinct from the wearable device.

(A3) In some embodiments of any of A1-A2, initiating performance of the application-specific action includes one or more of (i) causing an application on the wearable device to open, (ii) causing a portion of a user interface of an application to be presented on the wearable device to be populated with one or more user inputs, (iii) causing an application on the wearable device to perform an application specific operation, and (iv) causing an application to initiate an interaction with a predefined contact associated with the character.

(A4) In some embodiments of any of A1-A3, the text-symbolic hand gesture is a first text-symbolic hand gesture and the character is a first character, and the method further includes detecting, by the wearable device worn by the user, a second text-symbolic hand gesture performed by the user. The method further includes, in response to detecting the second text-symbolic hand gesture and in accordance with a determination that a second character identified from the second text-symbolic hand gesture is a linking character that connects to the first character to form a set of characters, causing the display communicatively coupled with the wearable device to present (i) a representation of an application-specific action associated with the set of characters and (ii) an updated predicted user input based on the set of characters.

(A5) In some embodiments of any of A1-A4, the text-symbolic hand gesture is a first text-symbolic hand gesture and the character is a first character, and the method further includes detecting, by the wearable device worn by the user, a third text-symbolic hand gesture performed by the user. The method further includes, in response to detecting the third text-symbolic hand gesture and in accordance with a determination that a third character identified from the second text-symbolic hand gesture is a non-linking character that is not connected to the first character such that the first character forms a first set of characters and the third character forms a second set of characters, causing the display communicatively coupled with the wearable device to present (i) a representation of an application-specific action associated with the first and second set of characters and (ii) an updated predicted user input based on the first and second set of characters.

(A6) In some embodiments of any of A4-A5, the method further includes detecting, by the wearable device worn by the user, another input performed by the user; and, in response to a determination that the other input selects one or more sets of characters, providing instructions that cause the wearable device to perform an operation associated with the one or more sets of characters.

(A7) In some embodiments of A6, the operation associated with the respective set of characters includes one or more of (i) causing an application on the wearable device to open, (ii) causing a portion of a user interface presented on the wearable device to be populated with a predetermined input, and (iii) causing the wearable device to initiate an interaction with a predefined contact associated with the character.

(A8) In some embodiments of A7, the text-symbolic hand gesture is a swipe typing gesture.

(A9) In some embodiments of any of A1-A8, the text-symbolic hand gesture is a surface typing gesture.

(A10) In some embodiments of any of A1-A9, the text-symbolic hand gesture is a handwriting gesture.

(A11) In some embodiments of A10, the handwriting gesture is user specific shorthand and the determination that the text-symbolic hand gesture is associated with the character includes interpreting the user specific shorthand based on historic user data.

(A12) In some embodiments of any of A10-A11, the handwriting gesture is a learned gesture generated by the wearable device and historic user data, wherein the learned gesture is specific to the user.

(A13) In some embodiments of any of A1-A12, the character determined based on the text-symbolic hand gesture has a character error rate less than 10 percent.

(A14) In some embodiments of any of A1-A13, the character and/or predicted user input are determined such that the rate at which the user generates one or more words is at least 20 words per minute.

(A15) In some embodiments of any of A1-A14, the text-symbolic hand gesture is a visually imperceptible hand gesture.

(A16) In some embodiments of any of A1-A15, the determination that the text-symbolic hand gesture is associated with a character includes comparing image and/or sensor data captured by the wearable device with stored character data including predefined character data, user specific character data, user-device specific character data; and selecting, based on comparison of the image and/or sensor data with the stored character data, the character.

(A17) In some embodiments of any of A1-A16, the respective hand gestures are detected based on image data captured by the wearable device.

(A18) In some embodiments of any of A1-A16, the respective hand gestures are detected based on sensor data captured by the wearable device.

(A19) In some embodiments of any of A1-A16, the respective hand gestures are detected based on sensor data and image data captured by the wearable device.

(A20) In some embodiments of any of A1-A19, the predicted user input includes one or more a word, a sentence, a name, a date, a time, an abbreviation, an acronym, and an application.

(B1) In accordance with some embodiments, a method of detecting handwriting is disclosed. The method includes detecting, by a wearable device worn by a user, a text-symbolic hand gesture performed by the user. The method includes, in response to a determination that the text-symbolic hand gesture is associated with a character, determining a predicted user input based on the character, and causing a display communicative coupled with the wearable device to present (i) the character and (ii) the predicted user input. The method also includes detecting, by the wearable device worn by the user, a subsequent hand gesture performed by the user, and, in response to a determination that the subsequent hand gesture selects the predicted user input, providing instructions that cause the wearable device to perform an operation associated with the predicted user input. The method further includes, in response to a determination that the subsequent hand gesture selects the character, providing instructions that cause the wearable device to perform an operation associated with the character.

(B2) In some embodiments of B1, the operation associated with the predicted user input includes one or more of (i) causing an application on the wearable device to open, (ii) causing a portion of a user interface presented by the wearable device to be populated, (ii) causing the predicted user input to be shared with another electronic device distinct from the wearable device, and (iv) causing the wearable device to initiate an interaction with a predefined contact associated with the predicted user input.

(B3) In some embodiments of any of B1-B2, the operation associated with the character includes one or more of (i) causing an application on the wearable device to open, (ii) causing a portion of a user interface presented on the wearable device to be populated with a predetermined input, and (iii) causing the wearable device to initiate an interaction with a predefined contact associated with the character.

(B4) In some embodiments of any of B1-B3, the text-symbolic hand gesture is a first text-symbolic hand gesture and the character is a first character, and the method further includes detecting, by the wearable device worn by the user, a second text-symbolic hand gesture performed by the user. The method further includes, in response to a determination that the second text-symbolic hand gesture is associated with a second character and in accordance with a determination that the second character is a linking character that connects to the first character to form a set of characters, updating the predicted user input based on the set of characters, and causing the display communicative coupled with the wearable device to present (i) the set of characters and (ii) an updated predicted user input.

(B5) In some embodiments of any of B1-B4, the text-symbolic hand gesture is a first text-symbolic hand gesture and the character is a first character, and the method further includes detecting, by the wearable device worn by the user, a third text-symbolic hand gesture performed by the user. The method further includes, in response to a determination that the third text-symbolic hand gesture is associated with a third character and in accordance with a determination that the third character is a non-linking character that is not connected to the first character such that the first character forms a first set of characters and the third character forms a second set of characters, updating the predicted user input based on the first and second set of characters, and causing the display communicative coupled with the wearable device to present (i) the first and second set of character and (ii) an updated predicted user input.

(B6) In some embodiments of any of B1-B5, the method further includes the operations of the method of any of A6-A20.

(C1) In accordance with some embodiments, a wrist-wearable device used in conjunction with performance of the method of any one of A1-A20 or B1-B6.

(D1) In accordance with some embodiments, a non-transitory, computer-readable storage medium including instructions that, when executed by a computing device communicatively coupled with a wrist-wearable device, cause the wrist-wearable device to perform or cause performance of the method of any one of A1-A20 or B1-B6.

(E1) In accordance with some embodiments, a system including a head-worn wearable device and a wrist-wearable device, the system configured to perform the method of any one of A1-A20 or B1-B6 using the head-worn wearable device and the wrist-wearable device.

(F1) In accordance with some embodiments, a non-transitory, computer-readable storage medium including instructions that, when executed by a computing device communicatively coupled with a head-worn wearable device, cause the head-worn wearable device to perform or cause performance of the method of any one of A1-A20 or B1-B6.

(G1) In another aspect, a means on a wrist-wearable device, head-wearable device, and/or intermediary device for performing or causing performance of the method of any of A1-A20 or B1-B6.

(H1) In accordance with some embodiments, a non-transitory, computer-readable storage medium including instructions that, when executed by an intermediary device communicatively coupled with another device (e.g., a wrist-wearable device, a head-wearable device, etc.), cause the intermediary device or the other device to perform or cause performance of the method of any one of A1-A20 or B1-B6.

(I1) In accordance with some embodiments, a head-wearable device used in conjunction with performance of the method of any one of A1-A20 or B1-B6.

(J1) In accordance with some embodiments, an intermediary device used in conjunction with performance of the method of any one of A1-A20 or B1-B6.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 700, a head-wearable device, an HIPD 900, a smart textile-based garment (not shown), or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

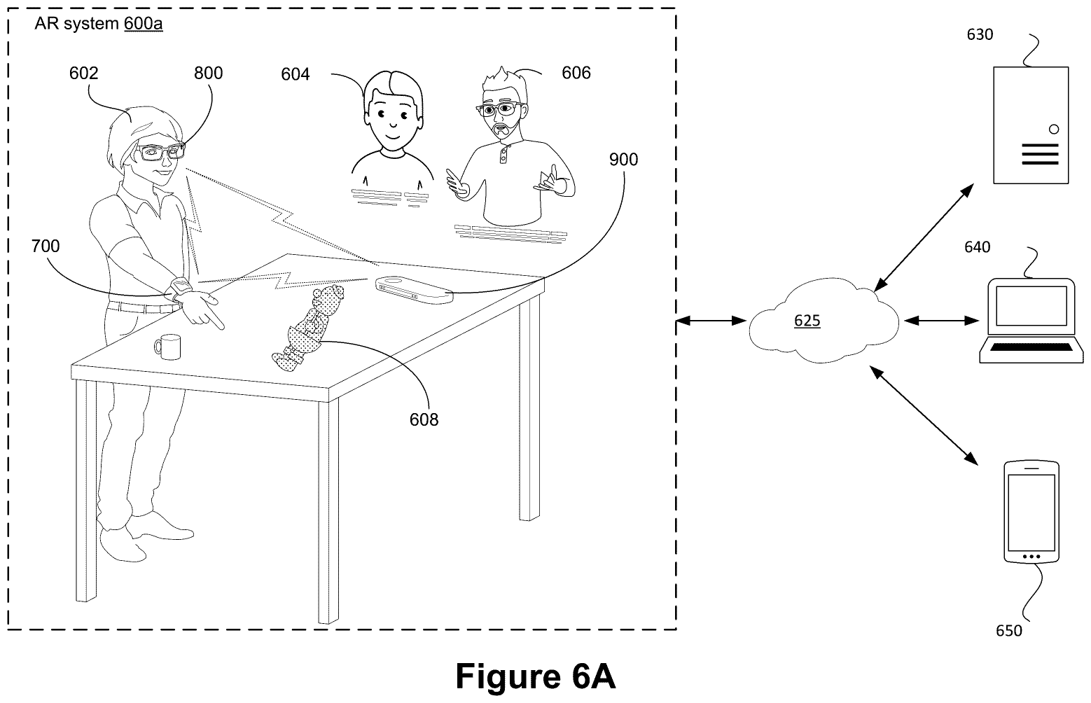

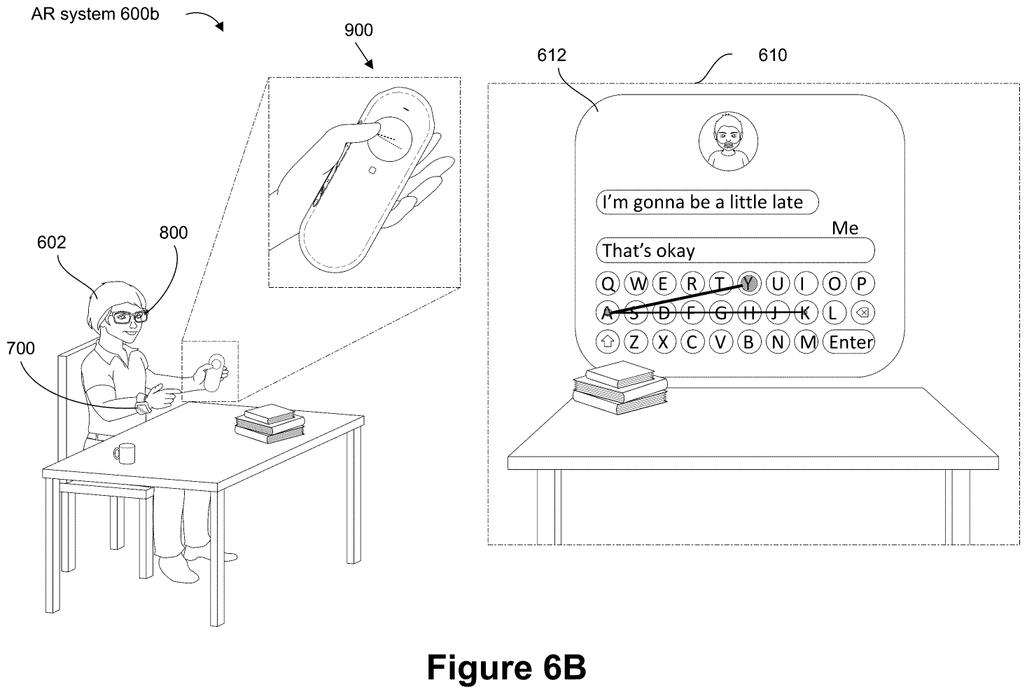

FIGS. 6A and 6B illustrate example artificial-reality systems, in accordance with some embodiments. FIG. 6A shows a first AR system 600a and first example user interactions using a wrist-wearable device 700, a head-wearable device (e.g., AR device 800), and/or a handheld intermediary processing device (HIPD) 900. FIG. 6B shows a second AR system 600b and second example user interactions using a wrist-wearable device 700, AR device 800, and/or an HIPD 900. As the skilled artisan will appreciate upon reading the descriptions provided herein, the above-example AR systems (described in detail below) can perform various functions and/or operations described above with reference to FIGS. 1A-5.

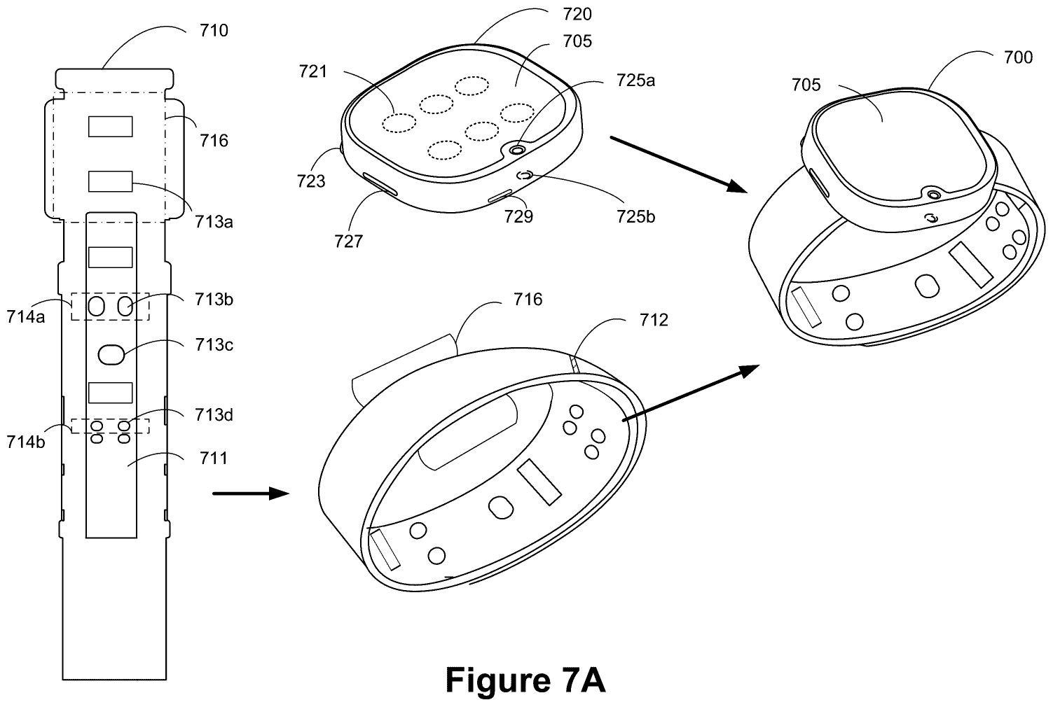

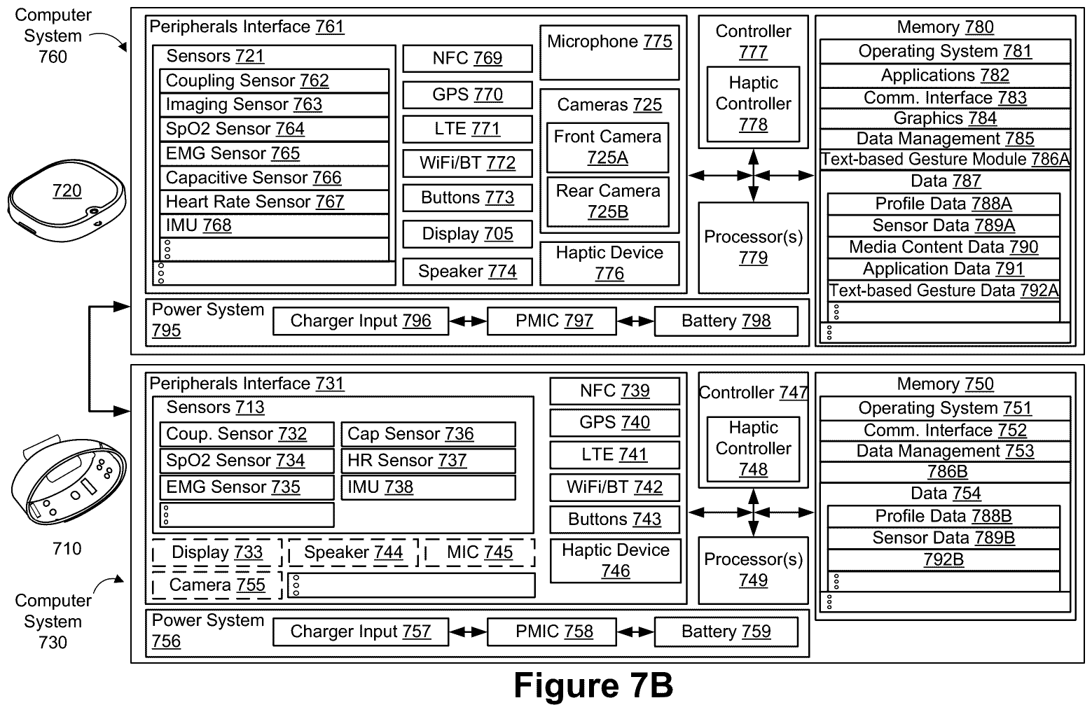

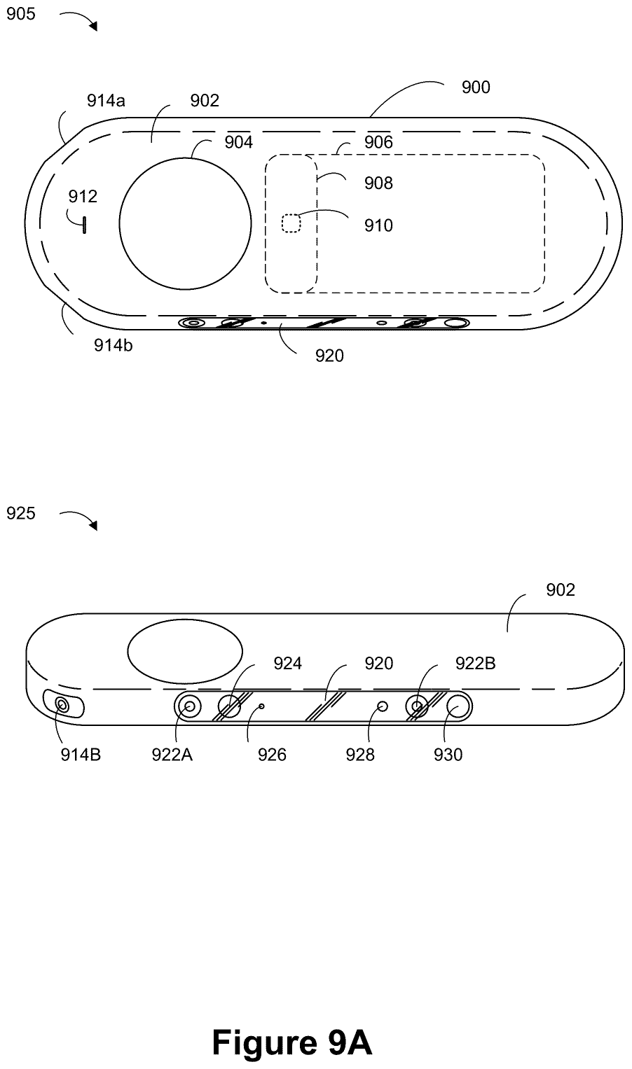

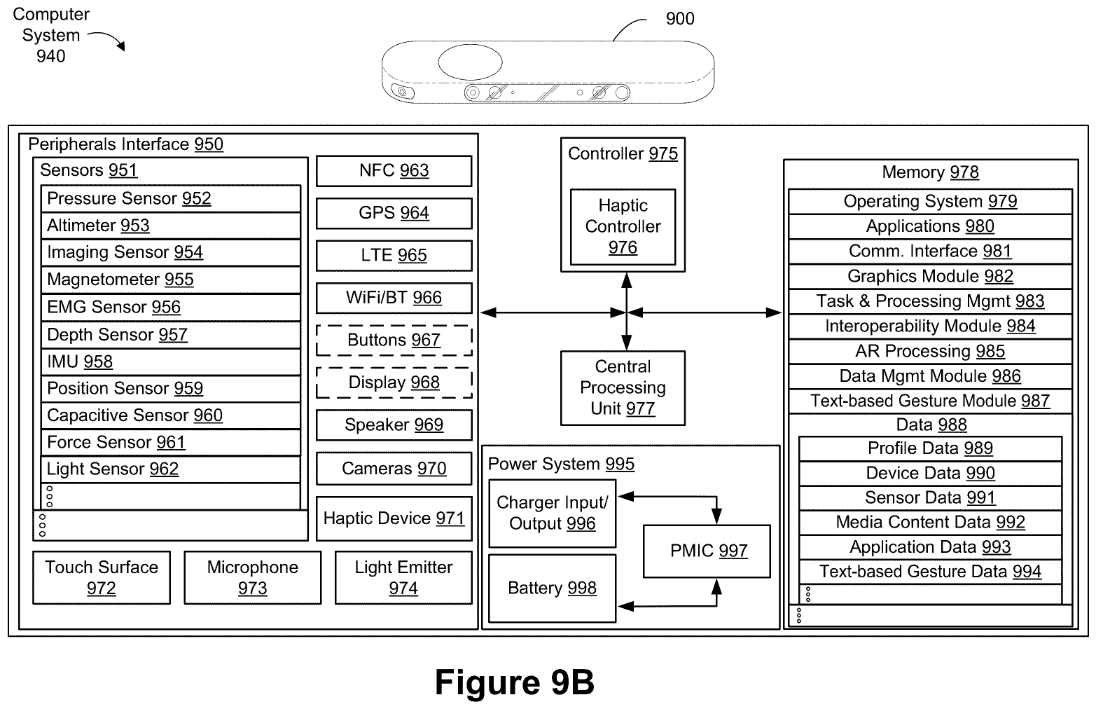

The wrist-wearable device 700 and its constituent components are described below in reference to FIGS. 7A-7B, the head-wearable devices and their constituent components are described below in reference to FIGS. 8A-8D, and the HIPD 900 and its constituent components are described below in reference to FIGS. 9A-9B. The wrist-wearable device 700, the head-wearable devices, and/or the HIPD 900 can communicatively couple via a network 625 (e.g., cellular, near field, Wi-Fi, personal area network, wireless LAN, etc.). Additionally, the wrist-wearable device 700, the head-wearable devices, and/or the HIPD 900 can also communicatively couple with one or more servers 630, computers 640 (e.g., laptops, computers, etc.), mobile devices 650 (e.g., smartphones, tablets, etc.), and/or other electronic devices via the network 625 (e.g., cellular, near field, Wi-Fi, personal area network, wireless LAN, etc.).

Turning to FIG. 6A, a user 602 is shown wearing the wrist-wearable device 700 and the AR device 800, and having the HIPD 900 on their desk. The wrist-wearable device 700, the AR device 800, and the HIPD 900 facilitate user interaction with an AR environment. In particular, as shown by the first AR system 600a, the wrist-wearable device 700, the AR device 800, and/or the HIPD 900 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 700, the AR device 800, and/or the HIPD 900.

The user 602 can use any of the wrist-wearable device 700, the AR device 800, and/or the HIPD 900 to provide user inputs. For example, the user 602 can perform one or more hand gestures that are detected by the wrist-wearable device 700 (e.g., using one or more EMG sensors and/or IMUs, described below in reference to FIGS. 7A-7B) and/or AR device 800 (e.g., using one or more image sensors or cameras, described below in reference to FIGS. 8A-8B) to provide a user input. Alternatively, or additionally, the user 602 can provide a user input via one or more touch surfaces of the wrist-wearable device 700, the AR device 800, and/or the HIPD 900, and/or voice commands captured by a microphone of the wrist-wearable device 700, the AR device 800, and/or the HIPD 900. In some embodiments, the wrist-wearable device 700, the AR device 800, and/or the HIPD 900 include a digital assistant to help the user in providing a user input (e.g., completing a sequence of operations, suggesting different operations or commands, providing reminders, confirming a command). In some embodiments, the user 602 can provide a user input via one or more facial gestures and/or facial expressions. For example, cameras of the wrist-wearable device 700, the AR device 800, and/or the HIPD 900 can track the user 602's eyes for navigating a user interface.

The wrist-wearable device 700, the AR device 800, and/or the HIPD 900 can operate alone or in conjunction to allow the user 602 to interact with the AR environment. In some embodiments, the HIPD 900 is configured to operate as a central hub or control center for the wrist-wearable device 700, the AR device 800, and/or another communicatively coupled device. For example, the user 602 can provide an input to interact with the AR environment at any of the wrist-wearable device 700, the AR device 800, and/or the HIPD 900, and the HIPD 900 can identify one or more back-end and front-end tasks to cause the performance of the requested interaction and distribute instructions to cause the performance of the one or more back-end and front-end tasks at the wrist-wearable device 700, the AR device 800, and/or the HIPD 900. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIGS. 9A-9B, the HIPD 900 can perform the back-end tasks and provide the wrist-wearable device 700 and/or the AR device 800 operational data corresponding to the performed back-end tasks such that the wrist-wearable device 700 and/or the AR device 800 can perform the front-end tasks. In this way, the HIPD 900, which has more computational resources and greater thermal headroom than the wrist-wearable device 700 and/or the AR device 800, performs computationally intensive tasks and reduces the computer resource utilization and/or power usage of the wrist-wearable device 700 and/or the AR device 800.

In the example shown by the first AR system 600a, the HIPD 900 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 900 performs back-end tasks for processing and/or rendering image data (and other data) associated with the AR video call and provides operational data associated with the performed back-end tasks to the AR device 800 such that the AR device 800 performs front-end tasks for presenting the AR video call (e.g., presenting the avatar 604 and the digital representation of the contact 606).

In some embodiments, the HIPD 900 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 900. In particular, the HIPD 900 and the AR device 800 operate in conjunction to determine a location for presenting the avatar 604 and the digital representation of the contact 606. In some embodiments, information can be presented within a predetermined distance from the HIPD 900 (e.g., within five meters). For example, as shown in the first AR system 600a, virtual object 608 is presented on the desk some distance from the HIPD 900. Similar to the above example, the HIPD 900 and the AR device 800 can operate in conjunction to determine a location for presenting the virtual object 608. Alternatively, in some embodiments, presentation of information is not bound by the HIPD 900. More specifically, the avatar 604, the digital representation of the contact 606, and the virtual object 608 do not have to be presented within a predetermined distance of the HIPD 900.

User inputs provided at the wrist-wearable device 700, the AR device 800, and/or the HIPD 900 are coordinated such that the user can use any device to initiate, continue, and/or complete an operation. For example, the user 602 can provide a user input to the AR device 800 to cause the AR device 800 to present the virtual object 608 and, while the virtual object 608 is presented by the AR device 800, the user 602 can provide one or more hand gestures via the wrist-wearable device 700 to interact and/or manipulate the virtual object 608.

FIG. 6B shows the user 602 wearing the wrist-wearable device 700 and the AR device 800, and holding the HIPD 900. In the second AR system 600b, the wrist-wearable device 700, the AR device 800, and/or the HIPD 900 are used to receive and/or provide one or more messages to a contact of the user 602. In particular, the wrist-wearable device 700, the AR device 800, and/or the HIPD 900 detect and coordinate one or more user inputs to initiate a messaging application and prepare a response to a received message via the messaging application.

In some embodiments, the user 602 initiates, via a user input, an application on the wrist-wearable device 700, the AR device 800, and/or the HIPD 900 that causes the application to initiate on at least one device. For example, in the second AR system 600b the user 602 performs a hand gesture associated with a command for initiating a messaging application (represented by messaging user interface 612); the wrist-wearable device 700 detects the hand gesture; and, based on a determination that the user 602 is wearing AR device 800, causes the AR device 800 to present a messaging user interface 612 of the messaging application. The AR device 800 can present the messaging user interface 612 to the user 602 via its display (e.g., as shown by user 602's field of view 610). In some embodiments, the application is initiated and can be run on the device (e.g., the wrist-wearable device 700, the AR device 800, and/or the HIPD 900) that detects the user input to initiate the application, and the device provides another device operational data to cause the presentation of the messaging application. For example, the wrist-wearable device 700 can detect the user input to initiate a messaging application, initiate and run the messaging application, and provide operational data to the AR device 800 and/or the HIPD 900 to cause presentation of the messaging application. Alternatively, the application can be initiated and run at a device other than the device that detected the user input. For example, the wrist-wearable device 700 can detect the hand gesture associated with initiating the messaging application and cause the HIPD 900 to run the messaging application and coordinate the presentation of the messaging application.

Further, the user 602 can provide a user input provided at the wrist-wearable device 700, the AR device 800, and/or the HIPD 900 to continue and/or complete an operation initiated at another device. For example, after initiating the messaging application via the wrist-wearable device 700 and while the AR device 800 presents the messaging user interface 612, the user 602 can provide an input at the HIPD 900 to prepare a response (e.g., shown by the swipe gesture performed on the HIPD 900). The user 602's gestures performed on the HIPD 900 can be provided and/or displayed on another device. For example, the user 602's swipe gestures performed on the HIPD 900 are displayed on a virtual keyboard of the messaging user interface 612 displayed by the AR device 800.

In some embodiments, the wrist-wearable device 700, the AR device 800, the HIPD 900, and/or other communicatively coupled devices can present one or more notifications to the user 602. The notification can be an indication of a new message, an incoming call, an application update, a status update, etc. The user 602 can select the notification via the wrist-wearable device 700, the AR device 800, or the HIPD 900 and cause presentation of an application or operation associated with the notification on at least one device. For example, the user 602 can receive a notification that a message was received at the wrist-wearable device 700, the AR device 800, the HIPD 900, and/or other communicatively coupled device and provide a user input at the wrist-wearable device 700, the AR device 800, and/or the HIPD 900 to review the notification, and the device detecting the user input can cause an application associated with the notification to be initiated and/or presented at the wrist-wearable device 700, the AR device 800, and/or the HIPD 900.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 800 can present to the user 602 game application data and the HIPD 900 can use a controller to provide inputs to the game. Similarly, the user 602 can use the wrist-wearable device 700 to initiate a camera of the AR device 800, and the user can use the wrist-wearable device 700, the AR device 800, and/or the HIPD 900 to manipulate the image capture (e.g., zoom in or out, apply filters, etc.) and capture image data.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 7A and 7B illustrate an example wrist-wearable device 700, in accordance with some embodiments. The wrist-wearable device 700 is an instance of the wearable device 120 described in reference to FIGS. 1A-5 herein, such that the wrist-wearable devices should be understood to have the features of the wrist-wearable device 700 and vice versa. FIG. 7A illustrates components of the wrist-wearable device 700, which can be used individually or in combination, including combinations that include other electronic devices and/or electronic components.

FIG. 7A shows a wearable band 710 and a watch body 720 (or capsule) being coupled, as discussed below, to form the wrist-wearable device 700. The wrist-wearable device 700 can perform various functions and/or operations associated with navigating through user interfaces and selectively opening applications, as well as the functions and/or operations described above with reference to FIGS. 1A-5.

As will be described in more detail below, operations executed by the wrist-wearable device 700 can include (i) presenting content to a user (e.g., displaying visual content via a display 705); (ii) detecting (e.g., sensing) user input (e.g., sensing a touch on peripheral button 723 and/or at a touch screen of the display 705, a hand gesture detected by sensors (e.g., biopotential sensors)); (iii) sensing biometric data via one or more sensors 713 (e.g., neuromuscular signals, heart rate, temperature, sleep, etc.); messaging (e.g., text, speech, video, etc.); image capture via one or more imaging devices or cameras 725; wireless communications (e.g., cellular, near field, Wi-Fi, personal area network, etc.); location determination; financial transactions; providing haptic feedback; alarms; notifications; biometric authentication; health monitoring; sleep monitoring.

The above-example functions can be executed independently in the watch body 720, independently in the wearable band 710, and/or via an electronic communication between the watch body 720 and the wearable band 710. In some embodiments, functions can be executed on the wrist-wearable device 700 while an AR environment is being presented (e.g., via one of the AR systems 600a and 600b). As the skilled artisan will appreciate upon reading the descriptions provided herein, the novel wearable devices described herein can be used with other types of AR environments.

The wearable band 710 can be configured to be worn by a user such that an inner (or inside) surface of the wearable structure 711 of the wearable band 710 is in contact with the user's skin. When worn by a user, sensors 713 contact the user's skin. The sensors 713 can sense biometric data such as a user's heart rate, saturated oxygen level, temperature, sweat level, neuromuscular signal sensors, or a combination thereof. The sensors 713 can also sense data about a user's environment, including a user's motion, altitude, location, orientation, gait, acceleration, position, or a combination thereof. In some embodiments, the sensors 713 are configured to track a position and/or motion of the wearable band 710. The one or more sensors 713 can include any of the sensors defined above and/or discussed below with respect to FIG. 7B.

The one or more sensors 713 can be distributed on an inside and/or an outside surface of the wearable band 710. In some embodiments, the one or more sensors 713 are uniformly spaced along the wearable band 710. Alternatively, in some embodiments, the one or more sensors 713 are positioned at distinct points along the wearable band 710. As shown in FIG. 7A, the one or more sensors 713 can be the same or distinct. For example, in some embodiments, the one or more sensors 713 can be shaped as a pill (e.g., sensor 713a), an oval, a circle a square, an oblong (e.g., sensor 713c) and/or any other shape that maintains contact with the user's skin (e.g., such that neuromuscular signal and/or other biometric data can be accurately measured at the user's skin). In some embodiments, the one or more sensors 713 are aligned to form pairs of sensors (e.g., for sensing neuromuscular signals based on differential sensing within each respective sensor). For example, sensor 713b is aligned with an adjacent sensor to form sensor pair 714a and sensor 713d is aligned with an adjacent sensor to form sensor pair 714b. In some embodiments, the wearable band 710 does not have a sensor pair. Alternatively, in some embodiments, the wearable band 710 has a predetermined number of sensor pairs (one pair of sensors, three pairs of sensors, four pairs of sensors, six pairs of sensors, sixteen pairs of sensors, etc.).

The wearable band 710 can include any suitable number of sensors 713. In some embodiments, the number and arrangements of sensors 713 depend on the particular application for which the wearable band 710 is used. For instance, a wearable band 710 configured as an armband, wristband, or chest-band may include a plurality of sensors 713 with different number of sensors 713 and different arrangement for each use case, such as medical use cases, compared to gaming or general day-to-day use cases.

In accordance with some embodiments, the wearable band 710 further includes an electrical ground electrode and a shielding electrode. The electrical ground and shielding electrodes, like the sensors 713, can be distributed on the inside surface of the wearable band 710 such that they contact a portion of the user's skin. For example, the electrical ground and shielding electrodes can be at an inside surface of coupling mechanism 716 or an inside surface of a wearable structure 711. The electrical ground and shielding electrodes can be formed and/or use the same components as the sensors 713. In some embodiments, the wearable band 710 includes more than one electrical ground electrode and more than one shielding electrode.

The sensors 713 can be formed as part of the wearable structure 711 of the wearable band 710. In some embodiments, the sensors 713 are flush or substantially flush with the wearable structure 711 such that they do not extend beyond the surface of the wearable structure 711. While flush with the wearable structure 711, the sensors 713 are still configured to contact the user's skin (e.g., via a skin-contacting surface). Alternatively, in some embodiments, the sensors 713 extend beyond the wearable structure 711 a predetermined distance (e.g., 0.1 mm to 2 mm) to make contact and depress into the user's skin. In some embodiments, the sensors 713 are coupled to an actuator (not shown) configured to adjust an extension height (e.g., a distance from the surface of the wearable structure 711) of the sensors 713 such that the sensors 713 make contact and depress into the user's skin. In some embodiments, the actuators adjust the extension height between 0.01 mm to 1.2 mm. This allows the user to customize the positioning of the sensors 713 to improve the overall comfort of the wearable band 710 when worn while still allowing the sensors 713 to contact the user's skin. In some embodiments, the sensors 713 are indistinguishable from the wearable structure 711 when worn by the user.

The wearable structure 711 can be formed of an elastic material, elastomers, etc., configured to be stretched and fitted to be worn by the user. In some embodiments, the wearable structure 711 is a textile or woven fabric. As described above, the sensors 713 can be formed as part of a wearable structure 711. For example, the sensors 713 can be molded into the wearable structure 711 or be integrated into a woven fabric (e.g., the sensors 713 can be sewn into the fabric and mimic the pliability of fabric (e.g., the sensors 713 can be constructed from a series of woven strands of fabric)).

The wearable structure 711 can include flexible electronic connectors that interconnect the sensors 713, the electronic circuitry, and/or other electronic components (described below in reference to FIG. 7B) that are enclosed in the wearable band 710. In some embodiments, the flexible electronic connectors are configured to interconnect the sensors 713, the electronic circuitry, and/or other electronic components of the wearable band 710 with respective sensors and/or other electronic components of another electronic device (e.g., watch body 720). The flexible electronic connectors are configured to move with the wearable structure 711 such that the user adjustment to the wearable structure 711 (e.g., resizing, pulling, folding, etc.) does not stress or strain the electrical coupling of components of the wearable band 710.

As described above, the wearable band 710 is configured to be worn by a user. In particular, the wearable band 710 can be shaped or otherwise manipulated to be worn by a user. For example, the wearable band 710 can be shaped to have a substantially circular shape such that it can be configured to be worn on the user's lower arm or wrist. Alternatively, the wearable band 710 can be shaped to be worn on another body part of the user, such as the user's upper arm (e.g., around a bicep), forearm, chest, legs, etc. The wearable band 710 can include a retaining mechanism 712 (e.g., a buckle, a hook and loop fastener, etc.) for securing the wearable band 710 to the user's wrist or other body part. While the wearable band 710 is worn by the user, the sensors 713 sense data (referred to as sensor data) from the user's skin. In particular, the sensors 713 of the wearable band 710 obtain (e.g., sense and record) neuromuscular signals.

The sensed data (e.g., sensed neuromuscular signals) can be used to detect and/or determine the user's intention to perform certain motor actions. In particular, the sensors 713 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 705 of the wrist-wearable device 700 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 713 can be used to provide a user with an enhanced interaction with a physical object (e.g., devices communicatively coupled with the wearable band 710) and/or a virtual object in an artificial-reality application generated by an artificial-reality system (e.g., user interface objects presented on the display 705 or another computing device (e.g., a smartphone)).

In some embodiments, the wearable band 710 includes one or more haptic devices 746 (FIG. 7B; e.g., a vibratory haptic actuator) that are configured to provide haptic feedback (e.g., a cutaneous and/or kinesthetic sensation, etc.) to the user's skin. The sensors 713, and/or the haptic devices 746 can be configured to operate in conjunction with multiple applications including, without limitation, health monitoring, social media, games, and artificial reality (e.g., the applications associated with artificial reality).

The wearable band 710 can also include coupling mechanism 716 (e.g., a cradle or a shape of the coupling mechanism can correspond to shape of the watch body 720 of the wrist-wearable device 700) for detachably coupling a capsule (e.g., a computing unit) or watch body 720 (via a coupling surface of the watch body 720) to the wearable band 710. In particular, the coupling mechanism 716 can be configured to receive a coupling surface proximate to the bottom side of the watch body 720 (e.g., a side opposite to a front side of the watch body 720 where the display 705 is located), such that a user can push the watch body 720 downward into the coupling mechanism 716 to attach the watch body 720 to the coupling mechanism 716. In some embodiments, the coupling mechanism 716 can be configured to receive a top side of the watch body 720 (e.g., a side proximate to the front side of the watch body 720 where the display 705 is located) that is pushed upward into the cradle, as opposed to being pushed downward into the coupling mechanism 716. In some embodiments, the coupling mechanism 716 is an integrated component of the wearable band 710 such that the wearable band 710 and the coupling mechanism 716 are a single unitary structure. In some embodiments, the coupling mechanism 716 is a type of frame or shell that allows the watch body 720 coupling surface to be retained within or on the wearable band 710 coupling mechanism 716 (e.g., a cradle, a tracker band, a support base, a clasp, etc.).

The coupling mechanism 716 can allow for the watch body 720 to be detachably coupled to the wearable band 710 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 720 to the wearable band 710 and to decouple the watch body 720 from the wearable band 710. For example, a user can twist, slide, turn, push, pull, or rotate the watch body 720 relative to the wearable band 710, or a combination thereof, to attach the watch body 720 to the wearable band 710 and to detach the watch body 720 from the wearable band 710. Alternatively, as discussed below, in some embodiments, the watch body 720 can be decoupled from the wearable band 710 by actuation of the release mechanism 729.

The wearable band 710 can be coupled with a watch body 720 to increase the functionality of the wearable band 710 (e.g., converting the wearable band 710 into a wrist-wearable device 700, adding an additional computing unit and/or battery to increase computational resources and/or a battery life of the wearable band 710, adding additional sensors to improve sensed data, etc.). As described above, the wearable band 710 (and the coupling mechanism 716) is configured to operate independently (e.g., execute functions independently) from watch body 720. For example, the coupling mechanism 716 can include one or more sensors 713 that contact a user's skin when the wearable band 710 is worn by the user and provide sensor data for determining control commands.

A user can detach the watch body 720 (or capsule) from the wearable band 710 in order to reduce the encumbrance of the wrist-wearable device 700 to the user. For embodiments in which the watch body 720 is removable, the watch body 720 can be referred to as a removable structure, such that in these embodiments the wrist-wearable device 700 includes a wearable portion (e.g., the wearable band 710) and a removable structure (the watch body 720).

Turning to the watch body 720, the watch body 720 can have a substantially rectangular or circular shape. The watch body 720 is configured to be worn by the user on their wrist or on another body part. More specifically, the watch body 720 is sized to be easily carried by the user, attached on a portion of the user's clothing, and/or coupled to the wearable band 710 (forming the wrist-wearable device 700). As described above, the watch body 720 can have a shape corresponding to the coupling mechanism 716 of the wearable band 710. In some embodiments, the watch body 720 includes a single release mechanism 729 or multiple release mechanisms (e.g., two release mechanisms 729 positioned on opposing sides of the watch body 720, such as spring-loaded buttons) for decoupling the watch body 720 and the wearable band 710. The release mechanism 729 can include, without limitation, a button, a knob, a plunger, a handle, a lever, a fastener, a clasp, a dial, a latch, or a combination thereof.

A user can actuate the release mechanism 729 by pushing, turning, lifting, depressing, shifting, or performing other actions on the release mechanism 729. Actuation of the release mechanism 729 can release (e.g., decouple) the watch body 720 from the coupling mechanism 716 of the wearable band 710, allowing the user to use the watch body 720 independently from wearable band 710, and vice versa. For example, decoupling the watch body 720 from the wearable band 710 can allow the user to capture images using rear-facing camera 725B. Although the coupling mechanism 716 is shown positioned at a corner of watch body 720, the release mechanism 729 can be positioned anywhere on watch body 720 that is convenient for the user to actuate. In addition, in some embodiments, the wearable band 710 can also include a respective release mechanism for decoupling the watch body 720 from the coupling mechanism 716. In some embodiments, the release mechanism 729 is optional and the watch body 720 can be decoupled from the coupling mechanism 716 as described above (e.g., via twisting, rotating, etc.).

The watch body 720 can include one or more peripheral buttons 723 and 727 for performing various operations at the watch body 720. For example, the peripheral buttons 723 and 727 can be used to turn on or wake (e.g., transition from a sleep state to an active state) the display 705, unlock the watch body 720, increase or decrease a volume, increase or decrease brightness, interact with one or more applications, interact with one or more user interfaces, etc. Additionally, or alternatively, in some embodiments, the display 705 operates as a touch screen and allows the user to provide one or more inputs for interacting with the watch body 720.

In some embodiments, the watch body 720 includes one or more sensors 721. The sensors 721 of the watch body 720 can be the same or distinct from the sensors 713 of the wearable band 710. The sensors 721 of the watch body 720 can be distributed on an inside and/or an outside surface of the watch body 720. In some embodiments, the sensors 721 are configured to contact a user's skin when the watch body 720 is worn by the user. For example, the sensors 721 can be placed on the bottom side of the watch body 720 and the coupling mechanism 716 can be a cradle with an opening that allows the bottom side of the watch body 720 to directly contact the user's skin. Alternatively, in some embodiments, the watch body 720 does not include sensors that are configured to contact the user's skin (e.g., including sensors internal and/or external to the watch body 720 that configured to sense data of the watch body 720 and the watch body 720's surrounding environment). In some embodiments, the sensors 713 are configured to track a position and/or motion of the watch body 720.

The watch body 720 and the wearable band 710 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 720 and the wearable band 710 can share data sensed by the sensors 713 and 721, as well as application- and device-specific information (e.g., active and/or available applications), output devices (e.g., display, speakers, etc.), input devices (e.g., touch screen, microphone, imaging sensors, etc.).

In some embodiments, the watch body 720 can include, without limitation, a front-facing camera 725A and/or a rear-facing camera 725B, sensors 721 (e.g., a biometric sensor, an IMU sensor, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 763; FIG. 7B), a touch sensor, a sweat sensor, etc.). In some embodiments, the watch body 720 can include one or more haptic devices 776 (FIG. 7B; a vibratory haptic actuator) that is configured to provide haptic feedback (e.g., a cutaneous and/or kinesthetic sensation, etc.) to the user. The sensors 721 and/or the haptic device 776 can also be configured to operate in conjunction with multiple applications including, without limitation, health-monitoring applications, social media applications, game applications, and artificial-reality applications (e.g., the applications associated with artificial reality).

As described above, the watch body 720 and the wearable band 710, when coupled, can form the wrist-wearable device 700. When coupled, the watch body 720 and wearable band 710 operate as a single device to execute functions (operations, detections, communications, etc.) described herein. In some embodiments, each device is provided with particular instructions for performing the one or more operations of the wrist-wearable device 700. For example, in accordance with a determination that the watch body 720 does not include neuromuscular signal sensors, the wearable band 710 can include alternative instructions for performing associated instructions (e.g., providing sensed neuromuscular signal data to the watch body 720 via a different electronic device). Operations of the wrist-wearable device 700 can be performed by the watch body 720 alone or in conjunction with the wearable band 710 (e.g., via respective processors and/or hardware components) and vice versa. In some embodiments, operations of the wrist-wearable device 700, the watch body 720, and/or the wearable band 710 can be performed in conjunction with one or more processors and/or hardware components of another communicatively coupled device (e.g., the HIPD 900; FIGS. 9A-9B).

As described below with reference to the block diagram of FIG. 7B, the wearable band 710 and/or the watch body 720 can each include independent resources required to independently execute functions. For example, the wearable band 710 and/or the watch body 720 can each include a power source (e.g., a battery), a memory, data storage, a processor (e.g., a central processing unit (CPU)), communications, a light source, and/or input/output devices.

FIG. 7B shows block diagrams of a computing system 730 corresponding to the wearable band 710, and a computing system 760 corresponding to the watch body 720, according to some embodiments. A computing system of the wrist-wearable device 700 includes a combination of components of the wearable band computing system 730 and the watch body computing system 760, in accordance with some embodiments.

The watch body 720 and/or the wearable band 710 can include one or more components shown in watch body computing system 760. In some embodiments, a single integrated circuit includes all or a substantial portion of the components of the watch body computing system 760 are included in a single integrated circuit. Alternatively, in some embodiments, components of the watch body computing system 760 are included in a plurality of integrated circuits that are communicatively coupled. In some embodiments, the watch body computing system 760 is configured to couple (e.g., via a wired or wireless connection) with the wearable band computing system 730, which allows the computing systems to share components, distribute tasks, and/or perform other operations described herein (individually or as a single device).

The watch body computing system 760 can include one or more processors 779, a controller 777, a peripherals interface 761, a power system 795, and memory (e.g., a memory 780), each of which are defined above and described in more detail below.

The power system 795 can include a charger input 796, a power-management integrated circuit (PMIC) 797, and a battery 798, each are which are defined above. In some embodiments, a watch body 720 and a wearable band 710 can have respective charger inputs (e.g., charger input 796 and 757), respective batteries (e.g., battery 798 and 759), and can share power with each other (e.g., the watch body 720 can power and/or charge the wearable band 710, and vice versa). Although watch body 720 and/or the wearable band 710 can include respective charger inputs, a single charger input can charge both devices when coupled. The watch body 720 and the wearable band 710 can receive a charge using a variety of techniques. In some embodiments, the watch body 720 and the wearable band 710 can use a wired charging assembly (e.g., power cords) to receive the charge. Alternatively, or in addition, the watch body 720 and/or the wearable band 710 can be configured for wireless charging. For example, a portable charging device can be designed to mate with a portion of watch body 720 and/or wearable band 710 and wirelessly deliver usable power to a battery of watch body 720 and/or wearable band 710. The watch body 720 and the wearable band 710 can have independent power systems (e.g., power system 795 and 756) to enable each to operate independently. The watch body 720 and wearable band 710 can also share power (e.g., one can charge the other) via respective PMICs (e.g., PMICs 797 and 758) that can share power over power and ground conductors and/or over wireless charging antennas.

In some embodiments, the peripherals interface 761 can include one or more sensors 721, many of which listed below are defined above. The sensors 721 can include one or more coupling sensors 762 for detecting when the watch body 720 is coupled with another electronic device (e.g., a wearable band 710). The sensors 721 can include imaging sensors 763 (one or more of the cameras 725 and/or separate imaging sensors 763 (e.g., thermal-imaging sensors)). In some embodiments, the sensors 721 include one or more SpO2 sensors 764. In some embodiments, the sensors 721 include one or more biopotential-signal sensors (e.g., EMG sensors 765, which may be disposed on a user-facing portion of the watch body 720 and/or the wearable band 710). In some embodiments, the sensors 721 include one or more capacitive sensors 766. In some embodiments, the sensors 721 include one or more heart rate sensors 767. In some embodiments, the sensors 721 include one or more IMUs 768. In some embodiments, one or more IMUs 768 can be configured to detect movement of a user's hand or other location that the watch body 720 is placed or held.

In some embodiments, the peripherals interface 761 includes an NFC component 769, a global-position system (GPS) component 770, a long-term evolution (LTE) component 771, and/or a Wi-Fi and/or Bluetooth communication component 772. In some embodiments, the peripherals interface 761 includes one or more buttons 773 (e.g., the peripheral buttons 723 and 727 in FIG. 7A), which, when selected by a user, cause operations to be performed at the watch body 720. In some embodiments, the peripherals interface 761 includes one or more indicators, such as a light emitting diode (LED), to provide a user with visual indicators (e.g., message received, low battery, an active microphone, and/or a camera, etc.).

The watch body 720 can include at least one display 705 for displaying visual representations of information or data to the user, including user-interface elements and/or three-dimensional (3D) virtual objects. The display can also include a touch screen for inputting user inputs, such as touch gestures, swipe gestures, and the like. The watch body 720 can include at least one speaker 774 and at least one microphone 775 for providing audio signals to the user and receiving audio input from the user. The user can provide user inputs through the microphone 775 and can also receive audio output from the speaker 774 as part of a haptic event provided by the haptic controller 778. The watch body 720 can include at least one camera 725, including a front-facing camera 725A and a rear-facing camera 725B. The cameras 725 can include ultra-wide-angle cameras, wide-angle cameras, fish-eye cameras, spherical cameras, telephoto cameras, a depth-sensing cameras, or other types of cameras.

The watch body computing system 760 can include one or more haptic controllers 778 and associated componentry (e.g., haptic devices 776) for providing haptic events at the watch body 720 (e.g., a vibrating sensation or audio output in response to an event at the watch body 720). The haptic controllers 778 can communicate with one or more haptic devices 776, such as electroacoustic devices, including a speaker of the one or more speakers 774 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 778 can provide haptic events to respective haptic actuators that are capable of being sensed by a user of the watch body 720. In some embodiments, the one or more haptic controllers 778 can receive input signals from an application of the applications 782.

In some embodiments, the computer system 730 and/or the computer system 760 can include memory 780, which can be controlled by a memory controller of the one or more controllers 777 and/or one or more processors 779. In some embodiments, software components stored in the memory 780 include one or more applications 782 configured to perform operations at the watch body 720. In some embodiments, the one or more applications 782 include games, word processors, messaging applications, calling applications, web browsers, social media applications, media streaming applications, financial applications, calendars, clocks, etc. In some embodiments, software components stored in the memory 780 include one or more communication interface modules 783 as defined above. In some embodiments, software components stored in the memory 780 include one or more graphics modules 784 for rendering, encoding, and/or decoding audio and/or visual data; and one or more data management modules 785 for collecting, organizing, and/or providing access to the data 787 stored in memory 780. In some embodiments, software components stored in the memory 780 include a text-based gesture module 786A, which is configured to perform the features described above in reference to FIGS. 1A-5. In some embodiments, one or more of applications 782 and/or one or more modules can work in conjunction with one another to perform various tasks at the watch body 720.

In some embodiments, software components stored in the memory 780 can include one or more operating systems 781 (e.g., a Linux-based operating system, an Android operating system, etc.). The memory 780 can also include data 787. The data 787 can include profile data 788A, sensor data 789A, media content data 790, application data 791, and text-based gesture data 792A, which stores data related to the performance of the features described above in reference to FIGS. 1A-5.

It should be appreciated that the watch body computing system 760 is an example of a computing system within the watch body 720, and that the watch body 720 can have more or fewer components than shown in the watch body computing system 760, combine two or more components, and/or have a different configuration and/or arrangement of the components. The various components shown in watch body computing system 760 are implemented in hardware, software, firmware, or a combination thereof, including one or more signal processing and/or application-specific integrated circuits.

Turning to the wearable band computing system 730, one or more components that can be included in the wearable band 710 are shown. The wearable band computing system 730 can include more or fewer components than shown in the watch body computing system 760, combine two or more components, and/or have a different configuration and/or arrangement of some or all of the components. In some embodiments, all, or a substantial portion of the components of the wearable band computing system 730 are included in a single integrated circuit. Alternatively, in some embodiments, components of the wearable band computing system 730 are included in a plurality of integrated circuits that are communicatively coupled. As described above, in some embodiments, the wearable band computing system 730 is configured to couple (e.g., via a wired or wireless connection) with the watch body computing system 760, which allows the computing systems to share components, distribute tasks, and/or perform other operations described herein (individually or as a single device).

The wearable band computing system 730, similar to the watch body computing system 760, can include one or more processors 749, one or more controllers 747 (including one or more haptics controller 748), a peripherals interface 731 that can include one or more sensors 713 and other peripheral devices, power source (e.g., a power system 756), and memory (e.g., a memory 750) that includes an operating system (e.g., an operating system 751), data (e.g., data 754 including profile data 788B, sensor data 789B, text-based gesture data 792B, etc.), and one or more modules (e.g., a communications interface module 752, a data management module 753, a text-based gesture module 786B, etc.).

The one or more sensors 713 can be analogous to sensors 721 of the computer system 760 in light of the definitions above. For example, sensors 713 can include one or more coupling sensors 732, one or more SpO2 sensors 734, one or more EMG sensors 735, one or more capacitive sensors 736, one or more heart rate sensors 737, and one or more IMU sensors 738.

The peripherals interface 731 can also include other components analogous to those included in the peripheral interface 761 of the computer system 760, including an NFC component 739, a GPS component 740, an LTE component 741, a Wi-Fi and/or Bluetooth communication component 742, and/or one or more haptic devices 776 as described above in reference to peripherals interface 761. In some embodiments, the peripherals interface 731 includes one or more buttons 743, a display 733, a speaker 744, a microphone 745, and a camera 755. In some embodiments, the peripherals interface 731 includes one or more indicators, such as an LED.

It should be appreciated that the wearable band computing system 730 is an example of a computing system within the wearable band 710, and that the wearable band 710 can have more or fewer components than shown in the wearable band computing system 730, combine two or more components, and/or have a different configuration and/or arrangement of the components. The various components shown in wearable band computing system 730 can be implemented in one or a combination of hardware, software, and firmware, including one or more signal processing and/or application-specific integrated circuits.

The wrist-wearable device 700 with respect to FIG. 7A is an example of the wearable band 710 and the watch body 720 coupled, so the wrist-wearable device 700 will be understood to include the components shown and described for the wearable band computing system 730 and the watch body computing system 760. In some embodiments, wrist-wearable device 700 has a split architecture (e.g., a split mechanical architecture or a split electrical architecture) between the watch body 720 and the wearable band 710. In other words, all of the components shown in the wearable band computing system 730 and the watch body computing system 760 can be housed or otherwise disposed in a combined watch device 700, or within individual components of the watch body 720, wearable band 710, and/or portions thereof (e.g., a coupling mechanism 716 of the wearable band 710).

The techniques described above can be used with any device for sensing neuromuscular signals, including the arm-wearable devices of FIG. 7A-7B, but could also be used with other types of wearable devices for sensing neuromuscular signals (such as body-wearable or head-wearable devices that might have neuromuscular sensors closer to the brain or spinal column).

In some embodiments, a wrist-wearable device 700 can be used in conjunction with a head-wearable device described below (e.g., AR device 800 and VR device 810) and/or an HIPD 900, and the wrist-wearable device 700 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 800 and VR device 810.

### Example Head-Wearable Devices

FIGS. 8A-8C show example head-wearable devices, in accordance with some embodiments. Head-wearable devices can include, but are not limited to, AR devices 810 (e.g., AR or smart eyewear devices, such as smart glasses, smart monocles, smart contacts, etc.), VR devices 810 (e.g., VR headsets, head-mounted displays (HMD) s, etc.), or other ocularly coupled devices. The AR devices 800 and the VR devices 810 are instances of the head-wearable devices 110 described in reference to FIGS. 1A-5 herein, such that the head-wearable device 110 should be understood to have the features of the AR devices 800 and/or the VR devices 810, and vice versa. The AR devices 800 and the VR devices 810 can perform various functions and/or operations associated with navigating through user interfaces and selectively opening applications, as well as the functions and/or operations described above with reference to FIGS. 1A-5.

In some embodiments, an AR system (e.g., AR systems 600a and 600b; FIGS. 6A and 6B) includes an AR device 800 (as shown in FIG. 8A) and/or VR device 810 (as shown in FIGS. 8B-1 and 8B-2). In some embodiments, the AR device 800 and the VR device 810 can include one or more analogous components (e.g., components for presenting interactive artificial-reality environments, such as processors, memory, and/or presentation devices, including one or more displays and/or one or more waveguides), some of which are described in more detail with respect to FIG. 8C. The head-wearable devices can use display projectors (e.g., display projector assemblies 807A and 807B) and/or waveguides for projecting representations of data to a user. Some embodiments of head-wearable devices do not include displays.

FIG. 8A shows an example visual depiction of the AR device 800 (e.g., which may also be described herein as augmented-reality glasses and/or smart glasses). The AR device 800 can work in conjunction with additional electronic components that are not shown in FIGS. 8A, such as a wearable accessory device and/or an intermediary processing device, in electronic communication or otherwise configured to be used in conjunction with the AR device 800. In some embodiments, the wearable accessory device and/or the intermediary processing device may be configured to couple with the AR device 800 via a coupling mechanism in electronic communication with a coupling sensor 824, where the coupling sensor 824 can detect when an electronic device becomes physically or electronically coupled with the AR device 800. In some embodiments, the AR device 800 can be configured to couple to a housing (e.g., a portion of frame 804 or temple arms 805), which may include one or more additional coupling mechanisms configured to couple with additional accessory devices. The components shown in FIG. 8A can be implemented in hardware, software, firmware, or a combination thereof, including one or more signal-processing components and/or application-specific integrated circuits (ASICs).

The AR device 800 includes mechanical glasses components, including a frame 804 configured to hold one or more lenses (e.g., one or both lenses 806-1 and 806-2). One of ordinary skill in the art will appreciate that the AR device 800 can include additional mechanical components, such as hinges configured to allow portions of the frame 804 of the AR device 800 to be folded and unfolded, a bridge configured to span the gap between the lenses 806-1 and 806-2 and rest on the user's nose, nose pads configured to rest on the bridge of the nose and provide support for the AR device 800, earpieces configured to rest on the user's ears and provide additional support for the AR device 800, temple arms 805 configured to extend from the hinges to the earpieces of the AR device 800, and the like. One of ordinary skill in the art will further appreciate that some examples of the AR device 800 can include none of the mechanical components described herein. For example, smart contact lenses configured to present artificial-reality to users may not include any components of the AR device 800.

The lenses 806-1 and 806-2 can be individual displays or display devices (e.g., a waveguide for projected representations). The lenses 806-1 and 806-2 may act together or independently to present an image or series of images to a user. In some embodiments, the lenses 806-1 and 806-2 can operate in conjunction with one or more display projector assemblies 807A and 807B to present image data to a user. While the AR device 800 includes two displays, embodiments of this disclosure may be implemented in AR devices with a single near-eye display (NED) or more than two NEDs.

The AR device 800 includes electronic components, many of which will be described in more detail below with respect to FIG. 8C. Some example electronic components are illustrated in FIG. 8A, including sensors 823-1, 823-2, 823-3, 823-4, 823-5, and 823-6, which can be distributed along a substantial portion of the frame 804 of the AR device 800. The different types of sensors are described below in reference to FIG. 8C. The AR device 800 also includes a left camera 839A and a right camera 839B, which are located on different sides of the frame 804. And the eyewear device includes one or more processors 848A and 848B (e.g., an integral microprocessor, such as an ASIC) that is embedded into a portion of the frame 804.

FIGS. 8B-1 and 8B-2 show an example visual depiction of the VR device 810 (e.g., a head-mounted display (HMD) 812, also referred to herein as an artificial-reality headset, a head-wearable device, a VR headset, etc.). The HMD 812 includes a front body 814 and a frame 816 (e.g., a strap or band) shaped to fit around a user's head. In some embodiments, the front body 814 and/or the frame 816 includes one or more electronic elements for facilitating presentation of and/or interactions with an AR and/or VR system (e.g., displays, processors (e.g., processor 848A-1), IMUs, tracking emitter or detectors, sensors, etc.). In some embodiments, the HMD 812 includes output audio transducers (e.g., an audio transducer 818-1), as shown in FIG. 8B-2. In some embodiments, one or more components, such as the output audio transducer(s) 818-1 and the frame 816, can be configured to attach and detach (e.g., are detachably attachable) to the HMD 812 (e.g., a portion or all of the frame 816, and/or the output audio transducer 818-1), as shown in FIG. 8B-2. In some embodiments, coupling a detachable component to the HMD 812 causes the detachable component to come into electronic communication with the HMD 812. The VR device 810 includes electronic components, many of which will be described in more detail below with respect to FIG. 8C

FIG. 8B-1 to 8B-2 also show that the VR device 810 one or more cameras, such as the left camera 839A and the right camera 839B, which can be analogous to the left and right cameras on the frame 804 of the AR device 800. In some embodiments, the VR device 810 includes one or more additional cameras (e.g., cameras 839C and 839D), which can be configured to augment image data obtained by the cameras 839A and 839B by providing more information. For example, the camera 839C can be used to supply color information that is not discerned by cameras 839A and 839B. In some embodiments, one or more of the cameras 839A to 839D can include an optional IR cut filter configured to remove IR light from being received at the respective camera sensors.

The VR device 810 can include a housing 890 storing one or more components of the VR device 810 and/or additional components of the VR device 810. The housing 890 can be a modular electronic device configured to couple with the VR device 810 (or an AR device 800) and supplement and/or extend the capabilities of the VR device 810 (or an AR device 800). For example, the housing 890 can include additional sensors, cameras, power sources, processors (e.g., processor 848A-2), etc. to improve and/or increase the functionality of the VR device 810. Examples of the different components included in the housing 890 are described below in reference to FIG. 8C.

Alternatively or in addition, in some embodiments, the head-wearable device, such as the VR device 810 and/or the AR device 800), includes, or is communicatively coupled to, another external device (e.g., a paired device), such as an HIPD 900 (discussed below in reference to FIGS. 9A-9B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 900, an optional neckband, and/or wearable accessory device) with the head-wearable devices (e.g., an AR device 800 and/or VR device 810) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 900) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 900, can process information generated by one or more sensors of its sensors and/or information provided by other communicatively coupled devices. For example, a head-wearable device can include an IMU, and the intermediary processing device (neckband and/or an HIPD 900) can compute all inertial and spatial calculations from the IMUs located on the head-wearable device. Additional examples of processing performed by a communicatively coupled device, such as the HIPD 900, are provided below in reference to FIGS. 9A and 9B.

Artificial-reality systems may include a variety of types of visual feedback mechanisms. For example, display devices in the AR devices 800 and/or the VR devices 810 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 800 and/or the VR device 810 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 800 and the VR device 810, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 800 and/or the VR device 810 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 700, an HIPD 900, smart textile-based garment (not shown), etc.), and/or other devices described herein.

FIG. 8C illustrates a computing system 820 and an optional housing 890, each of which show components that can be included in a head-wearable device (e.g., the AR device 800 and/or the VR device 810). In some embodiments, more or less components can be included in the optional housing 890 depending on practical restraints of the respective head-wearable device being described. Additionally or alternatively, the optional housing 890 can include additional components to expand and/or augment the functionality of a head-wearable device.

In some embodiments, the computing system 820 and/or the optional housing 890 can include one or more peripheral interfaces 822A and 822B, one or more power systems 842A and 842B (including charger input 843, PMIC 844, and battery 845), one or more controllers 846A 846B (including one or more haptic controllers 847), one or more processors 848A and 848B (as defined above, including any of the examples provided), and memory 850A and 850B, which can all be in electronic communication with each other. For example, the one or more processors 848A and/or 848B can be configured to execute instructions stored in the memory 850A and/or 850B, which can cause a controller of the one or more controllers 846A and/or 846B to cause operations to be performed at one or more peripheral devices of the peripherals interfaces 822A and/or 822B. In some embodiments, each operation described can occur based on electrical power provided by the power system 842A and/or 842B.

In some embodiments, the peripherals interface 822A can include one or more devices configured to be part of the computing system 820, many of which have been defined above and/or described with respect to wrist-wearable devices shown in FIGS. 7A and 7B. For example, the peripherals interface can include one or more sensors 823A. Some example sensors include: one or more coupling sensors 824, one or more acoustic sensors 825, one or more imaging sensors 826, one or more EMG sensors 827, one or more capacitive sensors 828, and/or one or more IMUs 829. In some embodiments, the sensors 823A further include depth sensors 867, light sensors 868 and/or any other types of sensors defined above or described with respect to any other embodiments discussed herein.

In some embodiments, the peripherals interface can include one or more additional peripheral devices, including one or more NFC devices 830, one or more GPS devices 831, one or more LTE devices 832, one or more WiFi and/or Bluetooth devices 833, one or more buttons 834 (e.g., including buttons that are slidable or otherwise adjustable), one or more displays 835A, one or more speakers 836A, one or more microphones 837A, one or more cameras 838A (e.g., including the a first camera 839-1 through nth camera 839-n, which are analogous to the left camera 839A and/or the right camera 839B), one or more haptic devices 840; and/or any other types of peripheral devices defined above or described with respect to any other embodiments discussed herein.

The head-wearable devices can include a variety of types of visual feedback mechanisms (e.g., presentation devices). For example, display devices in the AR device 800 and/or the VR device 810 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 835A can be coupled to each of the lenses 806-1 and 806-2 of the AR device 800. The displays 835A coupled to each of the lenses 806-1 and 806-2 can act together or independently to present an image or series of images to a user. In some embodiments, the AR device 800 and/or the VR device 810 includes a single display 835A (e.g., a near-eye display) or more than two displays 835A.

In some embodiments, a first set of one or more displays 835A can be used to present an augmented-reality environment, and a second set of one or more display devices 835A can be used to present a virtual-reality environment. In some embodiments, one or more waveguides are used in conjunction with presenting artificial-reality content to the user of the AR device 800 and/or the VR device 810 (e.g., as a means of delivering light from a display projector assembly and/or one or more displays 835A to the user's eyes). In some embodiments, one or more waveguides are fully or partially integrated into the AR device 800 and/or the VR device 810. Additionally, or alternatively to display screens, some artificial-reality systems include one or more projection systems. For example, display devices in the AR device 800 and/or the VR device 810 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 835A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 835A for presenting information to users. For example, an external display 835A can be used to show a current battery level, network activity (e.g., connected, disconnected, etc.), current activity (e.g., playing a game, in a call, in a meeting, watching a movie, etc.), and/or other relevant information. In some embodiments, the external displays 835A can be used to communicate with others. For example, a user of the head-wearable device can cause the external displays 835A to present a do not disturb notification. The external displays 835A can also be used by the user to share any information captured by the one or more components of the peripherals interface 822A and/or generated by head-wearable device (e.g., during operation and/or performance of one or more applications).

The memory 850A can include instructions and/or data executable by one or more processors 848A (and/or processors 848B of the housing 890) and/or a memory controller of the one or more controllers 846A (and/or controller 846B of the housing 890). The memory 850A can include one or more operating systems 851; one or more applications 852; one or more communication interface modules 853A; one or more graphics modules 854A; one or more AR processing modules 855A; text-based gesture modules 856 (analogous to the text-based gesture module 786; FIG. 7B); and/or any other types of modules or components defined above or described with respect to any other embodiments discussed herein.

The data 860 stored in memory 850A can be used in conjunction with one or more of the applications and/or programs discussed above. The data 860 can include profile data 861; sensor data 862; media content data 863; AR application data 864; text-based gesture data 865 (analogous to the text-based gesture data 792; FIG. 7B); and/or any other types of data defined above or described with respect to any other embodiments discussed herein.

In some embodiments, the controller 846A of the head-wearable devices processes information generated by the sensors 823A on the head-wearable devices and/or another component of the head-wearable devices and/or communicatively coupled with the head-wearable devices (e.g., components of the housing 890, such as components of peripherals interface 822B). For example, the controller 846A can process information from the acoustic sensors 825 and/or image sensors 826. For each detected sound, the controller 846A can perform a direction of arrival (DOA) estimation to estimate a direction from which the detected sound arrived at a head-wearable device. As one or more of the acoustic sensors 825 detects sounds, the controller 846A can populate an audio data set with the information (e.g., represented by sensor data 862).

In some embodiments, a physical electronic connector can convey information between the head-wearable devices and another electronic device, and/or between one or more processors 848A of the head-wearable devices and the controller 846A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 900) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 800 and/or the VR device 810 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 8B-1 and 8B-2 show the VR device 810 having cameras 839A-839D, which can be used to provide depth information for creating a voxel field and a two-dimensional mesh to provide object information to the user to avoid collisions.

The optional housing 890 can include analogous components to those describe above with respect to the computing system 820. For example, the optional housing 890 can include a respective peripherals interface 822B including more or less components to those described above with respect to the peripherals interface 822A. As described above, the components of the optional housing 890 can be used augment and/or expand on the functionality of the head-wearable devices. For example, the optional housing 890 can include respective sensors 823B, speakers 836B, displays 835B, microphones 837B, cameras 838B, and/or other components to capture and/or present data. Similarly, the optional housing 890 can include one or more processors 848B, controllers 846B, and/or memory 850B (including respective communication interface modules 853B; one or more graphics modules 854B; one or more AR processing modules 855B, etc.) that can be used individually and/or in conjunction with the components of the computing system 820.

The techniques described above in FIGS. 8A-8C can be used with different head-wearable devices. In some embodiments, the head-wearable devices (e.g., the AR device 800 and/or the VR device 810) can be used in conjunction with one or more wearable device such as a wrist-wearable device 700 (or components thereof), as well as an HIPD 900. Having thus described example the head-wearable devices, attention will now be turned to example handheld intermediary processing devices, such as HIPD 900.

### Example Handheld Intermediary Processing Devices

FIGS. 9A and 9B illustrate an example handheld intermediary processing device (HIPD) 900, in accordance with some embodiments. The HIPD 900 is an instance of the intermediary devices described in reference to FIGS. 1A-5 herein, such that the HIPD 900 should be understood to have the features described with respect to any intermediary device defined above or otherwise described herein, and vice versa. The HIPD 900 can perform various functions and/or operations associated with navigating through user interfaces and selectively opening applications, as well as the functions and/or operations described above with reference to FIGS. 1A-5.

FIG. 9A shows a top view 905 and a side view 925 of the HIPD 900. The HIPD 900 is configured to communicatively couple with one or more wearable devices (or other electronic devices) associated with a user. For example, the HIPD 900 is configured to communicatively couple with a user's wrist-wearable device 700 (or components thereof, such as the watch body 720 and the wearable band 710), AR device 800, and/or VR device 810. The HIPD 900 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 900 can successfully be communicatively coupled with an electronic device, such as a wearable device).

The HIPD 900 can perform various functions independently and/or in conjunction with one or more wearable devices (e.g., wrist-wearable device 700, AR device 800, VR device 810, etc.). The HIPD 900 is configured to increase and/or improve the functionality of communicatively coupled devices, such as the wearable devices. The HIPD 900 is configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 1A-5. Additionally, as will be described in more detail below, functionality and/or operations of the HIPD 900 can include, without limitation, task offloading and/or handoffs; thermals offloading and/or handoffs; 6 degrees of freedom (6DoF) raycasting and/or gaming (e.g., using imaging devices or cameras 914A and 914B, which can be used for simultaneous localization and mapping (SLAM) and/or with other image processing techniques); portable charging; messaging; image capturing via one or more imaging devices or cameras (e.g., cameras 922A and 922B); sensing user input (e.g., sensing a touch on a multi-touch input surface 902); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 900 and/or in communication between the HIPD 900 and another wearable device described herein. In some embodiments, functions can be executed on the HIPD 900 in conjunction with an AR environment. As the skilled artisan will appreciate upon reading the descriptions provided herein, the novel the HIPD 900 described herein can be used with any type of suitable AR environment.

While the HIPD 900 is communicatively coupled with a wearable device and/or other electronic device, the HIPD 900 is configured to perform one or more operations initiated at the wearable device and/or the other electronic device. In particular, one or more operations of the wearable device and/or the other electronic device can be offloaded to the HIPD 900 to be performed. The HIPD 900 performs the one or more operations of the wearable device and/or the other electronic device and provides to data corresponded to the completed operations to the wearable device and/or the other electronic device. For example, a user can initiate a video stream using AR device 800 and back-end tasks associated with performing the video stream (e.g., video rendering) can be offloaded to the HIPD 900, which the HIPD 900 performs and provides corresponding data to the AR device 800 to perform remaining front-end tasks associated with the video stream (e.g., presenting the rendered video data via a display of the AR device 800). In this way, the HIPD 900, which has more computational resources and greater thermal headroom than a wearable device, can perform computationally intensive tasks for the wearable device improving performance of an operation performed by the wearable device.

The HIPD 900 includes a multi-touch input surface 902 on a first side (e.g., a front surface) that is configured to detect one or more user inputs. In particular, the multi-touch input surface 902 can detect single tap inputs, multi-tap inputs, swipe gestures and/or inputs, force-based and/or pressure-based touch inputs, held taps, and the like. The multi-touch input surface 902 is configured to detect capacitive touch inputs and/or force (and/or pressure) touch inputs. The multi-touch input surface 902 includes a first touch-input surface 904 defined by a surface depression, and a second touch-input surface 906 defined by a substantially planar portion. The first touch-input surface 904 can be disposed adjacent to the second touch-input surface 906. In some embodiments, the first touch-input surface 904 and the second touch-input surface 906 can be different dimensions, shapes, and/or cover different portions of the multi-touch input surface 902. For example, the first touch-input surface 904 can be substantially circular and the second touch-input surface 906 is substantially rectangular. In some embodiments, the surface depression of the multi-touch input surface 902 is configured to guide user handling of the HIPD 900. In particular, the surface depression is configured such that the user holds the HIPD 900 upright when held in a single hand (e.g., such that the using imaging devices or cameras 914A and 914B are pointed toward a ceiling or the sky). Additionally, the surface depression is configured such that the user's thumb rests within the first touch-input surface 904.

In some embodiments, the different touch-input surfaces include a plurality of touch-input zones. For example, the second touch-input surface 906 includes at least a first touch-input zone 908 within a second touch-input zone 906 and a third touch-input zone 910 within the first touch-input zone 908. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 908 causes the HIPD 900 to perform a first command and a user input detected within the second touch-input zone 906 causes the HIPD 900 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 908 can be configured to detect force touch inputs (e.g., a magnitude at which the user presses down) and capacitive touch inputs, and the second touch-input zone 906 can be configured to detect capacitive touch inputs.

The HIPD 900 includes one or more sensors 951 for sensing data used in the performance of one or more operations and/or functions. For example, the HIPD 900 can include an IMU that is used in conjunction with cameras 914 for 3-dimensional object manipulation (e.g., enlarging, moving, destroying, etc. an object) in an AR or VR environment. Non-limiting examples of the sensors 951 included in the HIPD 900 include a light sensor, a magnetometer, a depth sensor, a pressure sensor, and a force sensor. Additional examples of the sensors 951 are provided below in reference to FIG. 9B.

The HIPD 900 can include one or more light indicators 912 to provide one or more notifications to the user. In some embodiments, the light indicators are LEDs or other types of illumination devices. The light indicators 912 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 904. The light indicators can be illuminated in different colors and/or patterns to provide the user with one or more notifications and/or information about the device. For example, a light indicator positioned around the first touch-input surface 904 can flash when the user receives a notification (e.g., a message), change red when the HIPD 900 is out of power, operate as a progress bar (e.g., a light ring that is closed when a task is completed (e.g., 0% to 100%)), operates as a volume indicator, etc.).

In some embodiments, the HIPD 900 includes one or more additional sensors on another surface. For example, as shown FIG. 9A, HIPD 900 includes a set of one or more sensors (e.g., sensor set 920) on an edge of the HIPD 900. The sensor set 920, when positioned on an edge of the of the HIPD 900, can be pe positioned at a predetermined tilt angle (e.g., 26 degrees), which allows the sensor set 920 to be angled toward the user when placed on a desk or other flat surface. Alternatively, in some embodiments, the sensor set 920 is positioned on a surface opposite the multi-touch input surface 902 (e.g., a back surface). The one or more sensors of the sensor set 920 are discussed in detail below.

The side view 925 of the of the HIPD 900 shows the sensor set 920 and camera 914B. The sensor set 920 includes one or more cameras 922A and 922B, a depth projector 924, an ambient light sensor 928, and a depth receiver 930. In some embodiments, the sensor set 920 includes a light indicator 926. The light indicator 926 can operate as a privacy indicator to let the user and/or those around them know that a camera and/or microphone is active. The sensor set 920 is configured to capture a user's facial expression such that the user can puppet a custom avatar (e.g., showing emotions, such as smiles, laughter, etc., on the avatar or a digital representation of the user). The sensor set 920 can be configured as a side stereo RGB system, a rear indirect Time-of-Flight (iToF) system, or a rear stereo RGB system. As the skilled artisan will appreciate upon reading the descriptions provided herein, the novel HIPD 900 described herein can use different sensor set 920 configurations and/or sensor set 920 placement.

In some embodiments, the HIPD 900 includes one or more haptic devices 971 (FIG. 9B; e.g., a vibratory haptic actuator) that are configured to provide haptic feedback (e.g., kinesthetic sensation). The sensors 951, and/or the haptic devices 971 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 900 is configured to operate without a display. However, in optional embodiments, the HIPD 900 can include a display 968 (FIG. 9B). The HIPD 900 can also income one or more optional peripheral buttons 967 (FIG. 9B). For example, the peripheral buttons 967 can be used to turn on or turn off the HIPD 900. Further, the HIPD 900 housing can be formed of polymers and/or elastomer elastomers. The HIPD 900 can be configured to have a non-slip surface to allow the HIPD 900 to be placed on a surface without requiring a user to watch over the HIPD 900. In other words, the HIPD 900 is designed such that it would not easily slide off a surfaces. In some embodiments, the HIPD 900 include one or magnets to couple the HIPD 900 to another surface. This allows the user to mount the HIPD 900 to different surfaces and provide the user with greater flexibility in use of the HIPD 900.

As described above, the HIPD 900 can distribute and/or provide instructions for performing the one or more tasks at the HIPD 900 and/or a communicatively coupled device. For example, the HIPD 900 can identify one or more back-end tasks to be performed by the HIPD 900 and one or more front-end tasks to be performed by a communicatively coupled device. While the HIPD 900 is configured to offload and/or handoff tasks of a communicatively coupled device, the HIPD 900 can perform both back-end and front-end tasks (e.g., via one or more processors, such as CPU 977; FIG. 9B). The HIPD 900 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 900 can perform the above operations alone or in conjunction with a wearable device (or other communicatively coupled electronic device).

FIG. 9B shows block diagrams of a computing system 940 of the HIPD 900, in accordance with some embodiments. The HIPD 900, described in detail above, can include one or more components shown in HIPD computing system 940. The HIPD 900 will be understood to include the components shown and described below for the HIPD computing system 940. In some embodiments, all, or a substantial portion of the components of the HIPD computing system 940 are included in a single integrated circuit. Alternatively, in some embodiments, components of the HIPD computing system 940 are included in a plurality of integrated circuits that are communicatively coupled.

The HIPD computing system 940 can include a processor (e.g., a CPU 977, a GPU, and/or a CPU with integrated graphics), a controller 975, a peripherals interface 950 that includes one or more sensors 951 and other peripheral devices, a power source (e.g., a power system 995), and memory (e.g., a memory 978) that includes an operating system (e.g., an operating system 979), data (e.g., data 988), one or more applications (e.g., applications 980), and one or more modules (e.g., a communications interface module 981, a graphics module 982, a task and processing management module 983, an interoperability module 984, an AR processing module 985, a data management module 986, a text-based gesture module 987 (analogous to the text-based gesture module 786; FIG. 7B), etc.). The HIPD computing system 940 further includes a power system 995 that includes a charger input and output 996, a PMIC 997, and a battery 998, all of which are defined above.

In some embodiments, the peripherals interface 950 can include one or more sensors 951. The sensors 951 can include analogous sensors to those described above in reference to FIG. 7B. For example, the sensors 951 can include imaging sensors 954, (optional) EMG sensors 956, IMUs 958, and capacitive sensors 960. In some embodiments, the sensors 951 can include one or more pressure sensor 952 for sensing pressure data, an altimeter 953 for sensing an altitude of the HIPD 900, a magnetometer 955 for sensing a magnetic field, a depth sensor 957 (or a time-of flight sensor) for determining a difference between the camera and the subject of an image, a position sensor 959 (e.g., a flexible position sensor) for sensing a relative displacement or position change of a portion of the HIPD 900, a force sensor 961 for sensing a force applied to a portion of the HIPD 900, and a light sensor 962 (e.g., an ambient light sensor) for detecting an amount of lighting. The sensors 951 can include one or more sensors not shown in FIG. 9B.

Analogous to the peripherals described above in reference to FIGS. 7B, the peripherals interface 950 can also include an NFC component 963, a GPS component 964, an LTE component 965, a Wi-Fi and/or Bluetooth communication component 966, a speaker 969, a haptic device 971, and a microphone 973. As described above in reference to FIG. 9A, the HIPD 900 can optionally include a display 968 and/or one or more buttons 967. The peripherals interface 950 can further include one or more cameras 970, touch surfaces 972, and/or one or more light emitters 974. The multi-touch input surface 902 described above in reference to FIG. 9A is an example of touch surface 972. The light emitters 974 can be one or more LEDs, lasers, etc. and can be used to project or present information to a user. For example, the light emitters 974 can include light indicators 912 and 926 described above in reference to FIG. 9A. The cameras 970 (e.g., cameras 914A, 914B, and 922 described above in FIG. 9A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 970 can be used for SLAM; 6 DoF ray casting, gaming, object manipulation, and/or other rendering; facial recognition and facial expression recognition, etc.

Similar to the watch body computing system 760 and the watch band computing system 730 described above in reference to FIG. 7B, the HIPD computing system 940 can include one or more haptic controllers 976 and associated componentry (e.g., haptic devices 971) for providing haptic events at the HIPD 900.

Memory 978 can include high-speed random-access memory and/or non-volatile memory, such as one or more magnetic disk storage devices, flash memory devices, or other non-volatile solid-state memory devices. Access to the memory 978 by other components of the HIPD 900, such as the one or more processors and the peripherals interface 950, can be controlled by a memory controller of the controllers 975.

In some embodiments, software components stored in the memory 978 include one or more operating systems 979, one or more applications 980, one or more communication interface modules 981, one or more graphics modules 982, one or more data management modules 985, which are analogous to the software components described above in reference to FIG. 7B. The software components stored in the memory 978 can also include the text-based gesture module 987.

In some embodiments, software components stored in the memory 978 include a task and processing management module 983 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 983 uses data 988 (e.g., device data 990) to distribute the one or more front-end and/or back-end tasks based on communicatively coupled devices' computing resources, available power, thermal headroom, ongoing operations, and/or other factors. For example, the task and processing management module 983 can cause the performance of one or more back-end tasks (of an operation performed at communicatively coupled AR device 800) at the HIPD 900 in accordance with a determination that the operation is utilizing a predetermined amount (e.g., at least 70%) of computing resources available at the AR device 800.

In some embodiments, software components stored in the memory 978 include an interoperability module 984 for exchanging and utilizing information received and/or provided to distinct communicatively coupled devices. The interoperability module 984 allows for different systems, devices, and/or applications to connect and communicate in a coordinated way without user input. In some embodiments, software components stored in the memory 978 include an AR module 985 that is configured to process signals based at least on sensor data for use in an AR and/or VR environment. For example, the AR processing module 985 can be used for 3D object manipulation, gesture recognition, facial and facial expression, recognition, etc.

The memory 978 can also include data 988, including structured data. In some embodiments, the data 988 can include profile data 989, device data 989 (including device data of one or more devices communicatively coupled with the HIPD 900, such as device type, hardware, software, configurations, etc.), sensor data 991, media content data 992, application data 993, and text-based gesture data 994 (analogous to the text-based gesture data 792; FIG. 7B).

It should be appreciated that the HIPD computing system 940 is an example of a computing system within the HIPD 900, and that the HIPD 900 can have more or fewer components than shown in the HIPD computing system 940, combine two or more components, and/or have a different configuration and/or arrangement of the components. The various components shown in HIPD computing system 940 are implemented in hardware, software, firmware, or a combination thereof, including one or more signal processing and/or application-specific integrated circuits.

The techniques described above in FIG. 9A-9B can be used with any device used as a human-machine interface controller. In some embodiments, an HIPD 900 can be used in conjunction with one or more wearable device such as a head-wearable device (e.g., AR device 800 and VR device 810) and/or a wrist-wearable device 700 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium including instructions that, when executed by a computing device communicatively coupled with a wrist-wearable device, cause the wrist-wearable device to perform:
detecting, by a wearable device worn by a user, a text-symbolic hand gesture performed by the user;
in response to detecting the text-symbolic hand gesture, causing a display communicatively coupled with the wearable device to present (i) a representation of an application-specific action associated with a character identified from the text-symbolic hand gesture and (ii) a predicted user input based on the character;
detecting, by the wearable device worn by the user, a subsequent input performed by the user;
in response to a determination that the subsequent input selects the predicted user input, providing instructions that cause the wearable device to initiate sending of the predicted user input to another electronic device; and
in response to a determination that the subsequent input selects the representation of the application-specific action associated with the character, providing instructions that cause the wearable device to initiate performance of the application-specific action.

2. The non-transitory, computer-readable storage medium of claim 1, wherein initiating sending of the predicted user input to another electronic device includes one or more of:
causing an application on the wearable device to send the predicted user input to the other electronic device,
causing a portion of a user interface presented by the wearable device to be populated with the predicted user input for review before sending,
causing the predicted user input to be shared with another electronic device distinct from the wearable device.

3. The non-transitory, computer-readable storage medium of claim 1, wherein initiating performance of the application-specific action includes one or more of:
causing an application on the wearable device to open,
causing a portion of a user interface of an application to be presented on the wearable device to be populated with one or more user inputs,
causing an application on the wearable device to perform an application specific operation, and
causing an application to initiate an interaction with a predefined contact associated with the character.

4. The non-transitory, computer-readable storage medium of claim 1, wherein the text-symbolic hand gesture is a first text-symbolic hand gesture and the character is a first character, and the instructions, when executed by the computing device, cause the wrist-wearable device to perform:
detecting, by the wearable device worn by the user, a second text-symbolic hand gesture performed by the user;
in response to detecting the second text-symbolic hand gesture and in accordance with a determination that a second character identified from the second text-symbolic hand gesture is a linking character that connects to the first character to form a set of characters, causing the display communicatively coupled with the wearable device to present (i) a representation of an application-specific action associated with the set of characters and (ii) an updated predicted user input based on the set of characters.

5. The non-transitory, computer-readable storage medium of claim 4, wherein the text-symbolic hand gesture is a first text-symbolic hand gesture and the character is a first character, and the instructions, when executed by the computing device, cause the wrist-wearable device to perform:
detecting, by the wearable device worn by the user, a third text-symbolic hand gesture performed by the user;
in response to detecting the third text-symbolic hand gesture and in accordance with a determination that a third character identified from the second text-symbolic hand gesture is a non-linking character that is not connected to the first character such that the first character forms a first set of characters and the third character forms a second set of characters, causing the display communicatively coupled with the wearable device to present (i) a representation of an application-specific action associated with the first and second set of characters and (ii) an updated predicted user input based on the first and second set of characters.

6. The non-transitory, computer-readable storage medium of claim 4, the instructions, when executed by the computing device, cause the wrist-wearable device to perform:
detecting, by the wearable device worn by the user, another input performed by the user;
in response to a determination that the other input selects one or more sets of characters, providing instructions that cause the wearable device to perform an operation associated with the one or more sets of characters.

7. The non-transitory, computer-readable storage medium of claim 6, wherein the operation associated with the respective set of characters includes one or more of:
causing an application on the wearable device to open,
causing a portion of a user interface presented on the wearable device to be populated with a predetermined input, and
causing the wearable device to initiate an interaction with a predefined contact associated with the character.

8. The non-transitory, computer-readable storage medium of claim 1, wherein the text-symbolic hand gesture is a swipe typing gesture.

9. The non-transitory, computer-readable storage medium of claim 1, wherein the text-symbolic hand gesture is a surface typing gesture.

10. The non-transitory, computer-readable storage medium of claim 1, wherein the text-symbolic hand gesture is a handwriting gesture.

11. The non-transitory, computer-readable storage medium of claim 10, wherein the handwriting gesture is user specific shorthand and the determination that the text-symbolic hand gesture is associated with the character includes interpreting the user specific shorthand based on historic user data.

12. The non-transitory, computer-readable storage medium of claim 10, wherein the handwriting gesture is a learned gesture generated by the wearable device and historic user data, wherein the learned gesture is specific to the user.

13. The non-transitory, computer-readable storage medium of claim 1, wherein the character determined based on the text-symbolic hand gesture has a character error rate less than 10 percent.

14. The non-transitory, computer-readable storage medium of claim 1, wherein the character and/or predicted user input are determined such that the rate at which the user generates one or more words is at least 20 words per minute.

15. The non-transitory, computer-readable storage medium of claim 1, wherein the text-symbolic hand gesture is a visually imperceptible hand gesture.

16. The non-transitory, computer-readable storage medium of claim 1, wherein the determination that the text-symbolic hand gesture is associated with a character includes:
comparing image and/or sensor data captured by the wearable device with stored character data including predefined character data, user specific character data, user-device specific character data; and
selecting, based on comparison of the image and/or sensor data with the stored character data, the character.

17. A method, comprising:
detecting, by a wearable device worn by a user, a text-symbolic hand gesture performed by the user;
in response to detecting the text-symbolic hand gesture, causing a display communicatively coupled with the wearable device to present (i) a representation of an application-specific action associated with a character identified from the text-symbolic hand gesture and (ii) a predicted user input based on the character;
detecting, by the wearable device worn by the user, a subsequent input performed by the user;
in response to a determination that the subsequent input selects the predicted user input, providing instructions that cause the wearable device to initiate sending of the predicted user input to another electronic device; and
in response to a determination that the subsequent input selects the representation of the application-specific action associated with the character, providing instructions that cause the wearable device to initiate performance of the application-specific action.

18. The method of claim 17, wherein initiating sending of the predicted user input to another electronic device includes one or more of:
causing an application on the wearable device to send the predicted user input to the other electronic device,
causing a portion of a user interface presented by the wearable device to be populated with the predicted user input for review before sending,
causing the predicted user input to be shared with another electronic device distinct from the wearable device.

19. A wrist-wearable device, comprising:
one or more sensors;
one or more processors; and
memory including instructions that, when executed by the one or more processors, cause the wrist-wearable device to:
detect, by a wearable device worn by a user, a text-symbolic hand gesture performed by the user;
in response to detecting the text-symbolic hand gesture, cause a display communicatively coupled with the wearable device to present (i) a representation of an application-specific action associated with a character identified from the text-symbolic hand gesture and (ii) a predicted user input based on the character;
detect, by the wearable device worn by the user, a subsequent input performed by the user;
in response to a determination that the subsequent input selects the predicted user input, provide instructions that cause the wearable device to initiate sending of the predicted user input to another electronic device; and
in response to a determination that the subsequent input selects the representation of the application-specific action associated with the character, provide instructions that cause the wearable device to initiate performance of the application-specific action.

20. The wrist-wearable device of claim 19, wherein initiating sending of the predicted user input to another electronic device includes one or more of:
causing an application on the wearable device to send the predicted user input to the other electronic device,
causing a portion of a user interface presented by the wearable device to be populated with the predicted user input for review before sending,
causing the predicted user input to be shared with another electronic device distinct from the wearable device.
